(19) United States
(12) Patent Application Publication
(10) Pub. No.: US 2022/0194650 A1
(43) Pub. Date: Jun. 23, 2022

(54) THERMOPLASTIC CONTAINERS COMPRISING AN INTEGRATED SEPARATING COMPONENT

(71) Applicant: RE-FOLD, LLC, San Francisco, CA (US)

(72) Inventor: Elise Friedman, San Francisco, CA (US)

(73) Assignee: RE-FOLD, LLC, San Francisco, CA (US)

(21) Appl. No.: 17/600,451

(22) PCT Filed: Apr. 1, 2020
(86) PCT No.: PCT/US2020/026242

§ 371 Date: Sep. 30, 2021

Related U.S. Application Data
(60) Provisional application No. 62/827,780, filed on Apr. 1, 2019.
(60) Provisional application No. 62/888,275, filed on Aug. 16, 2019.
(60) Provisional application No. 62/946,869, filed on Dec. 11, 2019.

(51) Int. Cl. B65D 1/22; B65D 1/40; B65D 17/00; B65D 17/28; B65D 65/46; B65D 1/02

(52) U.S. Cl. CPC B65D 1/225; B65D 1/40; B65D 17/04; B65D 2501/0054; B65D 65/466; B65D 1/0292; B65D 17/02; B65D 17/28

(57) ABSTRACT

Thermoplastic containers comprising an integrated separating component, as well as methods for converting the thermoplastic containers from a three-dimensional configuration into a configuration for enhanced recyclability, are provided. Systems and methods involving the thermoplastic containers are also provided.

### CROSS-REFERENCE TO RELATED APPLICATIONS

This application claims priority benefit of the filing date of U.S. Provisional Application No. 62/827,780, filed on Apr. 1, 2019, the disclosure of which application is herein incorporated by reference in its entirety. This application also claims priority benefit of the filing date of U.S. Provisional Application No. 62/888,275, filed on Aug. 16, 2019, the disclosure of which application is herein incorporated by reference in its entirety. This application also claims priority benefit of the filing date of U.S. Provisional Application No. 62/946,869, filed on Dec. 11, 2019, the disclosure of which application is herein incorporated by reference in its entirety.

### FIELD OF THE INVENTION

The present invention relates to thermoplastic containers comprising an integrated separating component, as well as methods for converting the thermoplastic containers from a three-dimensional configuration into a configuration for enhanced recyclability. Systems and methods involving the thermoplastic containers are also provided. The present invention also relates to a thermoplastic container comprising one or a plurality of integrated separating components to irreversibly separate the container into component parts of a predetermined configuration.

### BACKGROUND OF THE INVENTION

In November of 2018, the body of a dead sperm whale washed ashore on a beach in southern Indonesia. Daniel Victor, 1,000 Pieces of Plastic Found Inside Dead Whale in Indonesia, N.Y. TIMES, Nov. 21, 2018, available at https://www.nytimes.com/2018/11/21/world/asia/whale-plastics-indonesia.html. Inside the whale's stomach, volunteers from the World Wildlife Fund in Indonesia found 13 pounds of plastic trash, including 115 plastic cups, four plastic bottles, 25 plastic bags, two plastic flip-flops, and hundreds of miscellaneous pieces of plastic debris. Id. While the exact cause of the whale's death could not be determined, the large amount of undigestible plastic in its stomach certainly seems to have been a contributing factor. Similar stories are emerging across the globe: in June of 2018, a dead whale was found in Thailand, having nearly 18 pounds of plastic trash in its stomach; in Spain, a dead whale was found to have 64 pounds of trash clogging its intestines. Id.

In 2010, the top six plastic waste producers were all countries in Southeast Asia: China, Indonesia, the Philippines, Vietnam, Sri Lanka and Thailand; with the majority of the plastic waste coming in the form of single-use items that do not decompose, such as plastic bags, food packaging, straws, and cutlery. Id. While many countries are introducing legislation geared toward reducing plastic waste, the global scale of the epidemic presents a staggering challenge, particularly in economically disadvantaged populations. There is an urgent and alarming need for containers with enhanced recyclability that can address this world-wide crisis.

### SUMMARY OF THE INVENTION

Aspects of the invention include thermoplastic container comprising: a base having a perimeter and one or a plurality of edges along said perimeter; one or a plurality of wall segments extending from the one or plurality of edges along said perimeter of the base; and one or a plurality of integrated separating components configured to irreversibly separate the container into one or more component parts of a predetermined configuration.

In some embodiments, the one or the plurality of integrated separating components are configured to separate the thermoplastic container in a manner that allows the thermoplastic container to adopt a substantially flat configuration. In some embodiments, a thermoplastic container further comprises a rupture seam, wherein the integrated separating component is configured to separate the thermoplastic container along the rupture seam. In some embodiments, the rupture seam is impermeable to liquid. In some embodiments, the rupture seam is impermeable to air. In some embodiments, the rupture seam is permeable to liquid. In some embodiments, the rupture seam is permeable to air. In some embodiments, the rupture seam comprises a symmetric geometry. In some embodiments, the rupture seam comprises an asymmetric geometry.

In some embodiments, the integrated separating component comprises a wedging component that is configured to separate two or more components of the asymmetric geometry of the rupture seam. In some embodiments, the rupture seam is configured to generate a blunt edge following separation by the integrated separating component. In some embodiments, a thermoplastic container further comprises a rupture seam underlay that is configured to cover at least a portion of the rupture seam. In some embodiments, the rupture seam underlay is configured to cover an entire length of the rupture seam. In some embodiments, the rupture seam underlay is disposed on an interior surface of the thermoplastic container, an exterior surface of the thermoplastic container, or on both an interior surface and an exterior surface of the thermoplastic container. In some embodiments, the rupture seam underlay comprises a material that is impermeable to liquid. In some embodiments, the rupture seam underlay comprises a material that is impermeable to air. In some embodiments, the rupture seam underlay comprises a material that is different from the material of the thermoplastic container. In some embodiments, the rupture seam underlay comprises a material that has one or more different mechanical properties from the material of the thermoplastic container. In some embodiments, the integrated separating component is configured to separate the rupture seam underlay from the rupture seam as the integrated separating component moves along the rupture seam.

In some embodiments, a thermoplastic container further comprises: at least one wall trough; and at least one base trough disposed between an edge of the base and a wall segment; wherein at least one of the integrated separating components is configured to separate the thermoplastic container along the at least one wall trough and the at least one base trough. In some embodiments, a thermoplastic container further comprises a lid comprising a plurality of edges. In some embodiments, the lid is connected to at least one wall segment along at least a portion of at least one edge of the lid. In some embodiments, the lid is connected to at least one wall segment along an entire edge of the lid.

In some embodiments, the lid comprises a distal end and a proximal end; wherein the proximal end comprises a plurality of edges along its perimeter, and at least one lid trough disposed between a first edge of the lid and a wall segment; and wherein the integrated separating component is further configured to separate the thermoplastic container along the at least one lid trough. In some embodiments, the lid trough extends along an entire perimeter of the proximal end of the lid, and wherein the integrated separating component is configured to separate the thermoplastic container along the entire perimeter of the lid, thereby separating the lid from the thermoplastic container.

In some embodiments, the rupture seam, the base trough, the wall trough, and/or the lid trough comprises a guide component configured to guide the integrated separating component along a length of a rupture seam or a trough. In some embodiments, the guide component comprises a groove, or a combination of grooves, which are disposed within a trough. In some embodiments, the rupture seam, the base trough, the wall trough, and/or the lid trough comprises a retention component configured to retain the integrated separating component within a rupture seam or a trough. In some embodiments, the retention component comprises a groove, or a combination of grooves, which are disposed within a trough.

In some embodiments, the rupture seam, the base trough, the wall trough, and/or the lid trough comprises a thermoplastic material that is different from a thermoplastic material of the base, the wall segments, and/or the lid. In some embodiments, the rupture seam, the base trough, the wall trough, and/or the lid trough comprises a thermoplastic material that is the same as a thermoplastic material of the base, the wall segments, and/or the lid. In some embodiments, the rupture seam, the base trough, the wall trough, and/or the lid trough comprises a thermoplastic material that has one or more different mechanical properties from a thermoplastic material of the base, the wall segments, and/or the lid.

In some embodiments, the rupture seam, the base trough, the wall trough, and/or the lid trough comprises one or more direction-changing components that are configured to direct the integrated separating component to transition from a first rupture seam to a second rupture same, or from a first trough to a second trough, at a junction location.

In some embodiments, the integrated separating component comprises a tear-initiating component. In some embodiments, the tear-initiating component is configured to initiate a tear in the thermoplastic container, and the integrated separating component is configured to propagate the tear along a rupture seam, a base trough, a wall trough, and/or a lid trough.

In some embodiments, the integrated separating component comprises a pull tab.

In some embodiments, the integrated separating component is disposed within a depression. In some embodiments, the depression is disposed in the base, the lid, one or more wall segments, or any combination thereof. In some embodiments, the integrated separating component is configured to initiate a separation of the thermoplastic container upon removal of the integrated separating component from the depression.

In some embodiments, the integrated separating component comprises a guide component configured to guide the integrated separating component along a rupture seam or a trough. In some embodiments, the integrated separating component comprises a retention component configured to retain the integrated separating component within a rupture seam or a trough.

In some embodiments, the integrated separating component comprises a geometry that conforms to a geometry of a rupture seam, a base trough, a wall trough, and/or a lid trough. In some embodiments, the integrated separating component comprises a geometry that conforms to a geometry of a groove, or a combination of grooves, in a base trough, a wall trough, and/or a lid trough.

Aspects of the invention include thermoplastic containers further comprising: at least one angular wall component; wherein the integrated separating component is configured to separate the thermoplastic container along the at least one angular wall component. In some embodiments, the angular wall component comprises an angle that ranges from 110° to 45°. In some embodiments, the angular wall component comprises a guide component configured to guide the integrated separating component along a length of an angular wall component.

Aspects of the invention include thermoplastic containers comprising a recyclable material. In some embodiments, the recyclable material comprises a petroleum-based plastic material or a bioplastic material. In some embodiments, the recyclable material is a degradable material. In some embodiments, the degradable material is a biodegradable material. In some embodiments, the degradable material is a compostable material.

Aspects of the invention include systems comprising: a thermoplastic container, comprising: a base having a perimeter and one or a plurality of edges along said perimeter; one or a plurality of wall segments extending from the one or plurality of edges along said perimeter of the base; and one or a plurality of separating components configured to irreversibly separate the container into one or more component parts of a predetermined configuration. In some embodiments, the one or the plurality of separating components are configured to irreversibly separate the thermoplastic container in a manner that allows the thermoplastic container to adopt a substantially flat configuration. In some embodiments, the thermoplastic container further comprises a rupture seam.

Aspects of the invention include systems further comprising an apparatus configured to receive the thermoplastic container. In some embodiments, the separating component is disposed within the apparatus, and the apparatus is configured to actuate the separating component to irreversibly separate the thermoplastic container into component parts of a predetermined configuration. In some embodiments, the separating component is integrated into the thermoplastic container, and the apparatus is configured to operably couple to the integrated separating component and to actuate the separating component to irreversibly separate the thermoplastic container into component parts of a predetermined configuration.

Aspects of the invention include methods for converting a thermoplastic container from a first configuration to a second configuration, the method comprising: obtaining a thermoplastic container comprising: a base having a perimeter and one or a plurality of edges along said perimeter; one or a plurality of wall segments extending from the one or plurality of edges along said perimeter of the base; and one or a plurality of integrated separating components configured to irreversibly separate the container into one or more component parts of a predetermined configuration; and irreversibly separating the thermoplastic container to convert the thermoplastic container from the first configuration to the second configuration. In some embodiments, the second configuration is a substantially flat configuration. In some embodiments, the thermoplastic container comprises a rupture seam, and the method comprises separating the thermoplastic container along the rupture seam.

These and further aspects will be further explained in the rest of the disclosure, including the Examples.

### BRIEF DESCRIPTION OF THE DRAWINGS

FIG. 1, panels A-E, provide illustrations of various bases of thermoplastic containers in accordance with embodiments of the invention, as well as three-dimensional representations of containers created therefrom.

FIG. 2, panels A-D, provide illustrations of various wall segments in accordance with embodiments of the invention.

FIG. 3, panels A-C, provide illustrations showing a base and two adjoining wall segments, in accordance with embodiments of the invention.

FIG. 4, panels A-O, provide illustrations of various thermoplastic containers in accordance with embodiments of the invention.

FIG. 5, panels A-D, provide illustrations of various examples of thermoplastic containers in accordance with embodiments of the invention.

FIG. 6, panels A-F, provide illustrations of various troughs and grooves in accordance with embodiments of the invention.

FIG. 7, panels A-D, provide illustrations of various direction-changing components in accordance with embodiments of the invention.

FIG. 8, panels A-C, provide illustrations of various separating components in accordance with embodiments of the invention.

FIG. 9, panel A, provides an illustration of a recess, with a separating component positioned therein, in accordance with embodiments of the invention.

FIG. 10, panels A-D, provide illustrations of various separating components, positioned within a trough, in accordance with embodiments of the invention.

FIG. 11, panels A-D, provide illustrations of an angular wall component in accordance with some embodiments of the invention.

FIG. 12, panels A-B, provide illustrations of a rupture seam with an integrated separating component positioned therein, in accordance with some embodiments of the invention.

FIG. 13, panels A-B, provide illustrations of thermoplastic containers comprising a plurality of angular wall components, in accordance with some embodiments of the invention.

FIG. 14, panels A-C, provide illustrations of rupture seams in accordance with some embodiments of the invention.

FIG. 15, panels A-E, provide illustrations of several rupture seam underlays in accordance with some embodiments of the invention.

FIG. 16, panels A-E, provide illustrations of various separating components in accordance with embodiments of the invention.

FIG. 17, panels A-C, provide illustrations of a pull-tab separating component in accordance with one embodiment of the invention.

FIG. 18, panels A-B, provide illustrations of a multi-sided thermoplastic container in accordance with one embodiment of the invention.

FIG. 19, panels A-B, provide illustrations of another multi-sided thermoplastic container in accordance with one embodiment of the invention.

FIG. 20, panels A-C, provide illustrations of a two-shot injection molded container in accordance with one embodiment of the invention.

### DETAILED DESCRIPTION

Thermoplastic containers, systems and methods of use thereof are provided. Aspects of the subject thermoplastic containers include a base comprising a plurality of edges along its perimeter, a plurality of wall segments extending orthogonally from each edge of the base, and an integrated separating component configured to separate the thermoplastic container, thereby allowing the thermoplastic container to preferably adopt a substantially flat configuration. In some embodiments, a thermoplastic container further comprises at least one wall trough, and at least one base trough disposed between a first edge of the base and a wall segment, and the integrated separating component is configured to separate the thermoplastic container along the at least one wall trough and the at least one base trough, thereby allowing the thermoplastic container to adopt a substantially flat configuration. In some embodiments, a thermoplastic container comprises an angular wall component, and the integrated separating component is configured to separate the thermoplastic container along at least a portion of the angular wall component. In certain embodiments, a thermoplastic container comprises a rupture seam, and the integrated separating component is configured to separate the thermoplastic container along at least a portion of the rupture seam. Systems comprising, and methods for using, the subject thermoplastic containers are also described herein.

The practice of the present invention will employ, unless otherwise indicated, conventional techniques of thermoplastic manufacturing, as described, for example, in Christopher C. Ibeh, THERMOPLASTIC MATERIALS; PROPERTIES, MANUFACTURING METHODS, AND APPLICATIONS (CRC Press 2011).

Before the present invention is described in greater detail, it is to be understood that this invention is not limited to particular aspects described, as such may, of course, vary. It is also to be understood that the terminology used herein is for the purpose of describing particular aspects only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual aspects described and illustrated herein has discrete components and features which can be readily separated from or combined with the features of any of the other several aspects without departing from the scope or spirit of the present invention. Any recited method can be carried out in the order of events recited or in any other order which is logically possible.

### Definitions

By “comprising” it is meant that the recited elements are required in the composition, method, or system, but other elements may be included to form the composition/method/system, etc., within the scope of the claim.

By “consisting essentially of”, it is meant a limitation of the scope of a composition or method described to the specified materials or steps that do not materially affect the basic and novel characteristic(s) of the subject invention.

By “consisting of”, it is meant the exclusion from the composition, method, or system of any element, step, or ingredient not specified in the claim.

By “thermoplastic” is meant a polymeric material that becomes soft (i.e., moldable) when heated, and hardens when cooled, and which can be repeated at least once. The term “thermoplastic” is used in its broadest sense herein to refer to any polymeric type material having the recited functional properties, and is not to be construed as referring solely to synthetic polymeric materials. Such polymeric materials therefore may have some amount of crosslinking. The term “thermoplastic” specifically includes foamed thermoplastic materials, such as, but not limited to, foamed polystyrene materials.

By “orthogonal” is meant a direction that is generally or approximately perpendicular, while not necessarily forming an exact 90 degree angle. In some embodiments, “orthogonal” is used to describe, e.g., the relationship between a wall segment and a base segment, where the wall segment can form an angle with respect to the base segment that is approximately 90 degrees+/−30 degrees in either direction.

By “trough” is meant a relatively long, narrow, and shallow channel or depression.

By “trough edge” is meant either of the two upper-most portions that form the walls of the trough, which are positioned away from the floor, or bottom, of the trough.

By “groove” is meant a relatively long, narrow cut or depression, having dimensions that are smaller than those of a trough in which a groove is located.

By “angular wall component” is meant a component comprising two substantially planar features that are contiguous, and that are oriented at an angle to one another. For the avoidance of doubt, an angular wall component can be disposed at any position on a subject thermoplastic container, for example, within a base, within a lid, within a wall segment, between a base and a wall segment, between a lid and a wall segment, and/or between two wall segments.

By “rupture seam” is meant a location on a subject thermoplastic container where a user is intended to inflict a separation. In some embodiments, a rupture seam can comprise optical (e.g., color) properties that indicate its position to a user. In some embodiments, a rupture seam can comprise a material having one or more mechanical properties that facilitate separation of the container. In some embodiments, a rupture seam can comprise a geometry (e.g., a reduced thickness) that facilitates separation of the container. For example, in some embodiments, a rupture seam comprises a relatively long, narrow indentation that is configured to separate along the length of the indentation when appropriate force is applied. Rupture seams in accordance with embodiments of the invention can have any suitable permeability (e.g., permeable or impermeable to air, permeable or impermeable to liquid), geometry (e.g., symmetric or asymmetric), material properties (e.g., optical properties), mechanical properties, rupture strength, or any combination thereof.

By “rupture seam underlay” is meant a flap of material that is disposed along one or both sides of a rupture seam, and that substantially covers at least a portion the rupture seam.

By “symmetric geometry” is meant a geometry that is identical on either side of an axis, e.g., a longitudinal axis of a rupture seam.

By “asymmetric geometry” is meant a geometry that is not identical (i.e., is different) on either side of an axis, e.g., a longitudinal axis of a rupture seam.

By “wedging component” is meant a component comprising a blunt end and one or more inclined surfaces, and which is configured to convert a force applied to the blunt end into forces that are perpendicular to the one or more inclined surfaces.

By “distal” is meant situated away from the center of a body or object, or from the point of attachment.

By “proximal” is meant situated nearer to the center of a body or object, or from the point of attachment.

By “degradable material” is meant a material that will undergo a change in its chemical structure under specific environmental conditions resulting in a loss of some properties.

By “biodegradable material” is meant a material capable of being decomposed from the action of naturally occurring microorganisms, such as bacteria, fungi, etc., over a period of time.

By “compostable material” is meant a material that is capable of undergoing biological decomposition in a compost site, such that the material is not visually distinguishable and breaks down to carbon dioxide, water, inorganic compounds, and biomass, at a rate consistent with known compostable materials (e.g., cellulose) and leaves no toxic residue.

By “petroleum-based plastic” is meant a plastic material that is derived from petroleum and/or natural gas.

By “bioplastic” is meant a plastic material that is derived from renewable biomass. Non-limiting examples of bioplastics include those derived from sugar derivatives, such as starch, cellulose, or lactic acid.

### Thermoplastic Containers

Aspects of the invention include thermoplastic containers comprising: a base having a perimeter and one or a plurality of edges along said perimeter and one or a plurality of wall segments extending from the one or plurality of edges of said base. The container further includes one or a plurality of integrated separating components to irreversibly separate the container into component parts of a predetermined configuration.

Accordingly, thermoplastic containers in accordance with embodiments of the invention may have an initial geometry that defines the container, and then upon irreversible separation of the container into component parts of a predetermined configuration, the component parts are such that they facilitate the ability to recycle. For example, in some embodiments, the predetermined configuration and the component parts are such that they can pack together more efficiently and/or provide a configuration that facilitates feeding of the components into a recycling operation, as compared to the initial container geometry. Such recycling operation includes, but is not limited to, feeding one or more of the component parts into a granulator and/or feeding one or more of the component parts directly into a feed throat of an extruder and/or an injection molding machine. It is further contemplated that the predetermined configuration is one that allows for relatively more efficient shipping/storing from the perspective that one or more of the component parts of the predetermined configuration will define a relatively lower volume than what would otherwise be required when shipping/storing the thermoplastic container in its initial geometry.

Aspects of the invention include thermoplastic containers that are configured to preferably adopt a substantially flat configuration via the use of a separating component. Thermoplastic containers in accordance with embodiments of the invention generally comprise a base having a plurality of edges. Bases in accordance with embodiments of the invention can have any suitable size and thickness. For example, in some embodiments, a base has a dimension that ranges from about 1 mm up to about 2 m, such as about 2, 3, 4, 5, 6, 7, 8, or 9 mm, or about 1, 2, 3, 4, 5, 6, 7, 8, or about 9 cm, or about 1, 2, 3, 4, 5, 6, 7, 8, or 9 dm, or about 1, 1.1, 1.2, 1.3, 1.4, 1.5, 1.6, 1.7, 1.8, or 1.9 m. Bases in accordance with embodiments of the invention can have a thickness that ranges from about 0.01 mm to about 5 cm, such as about 0.02, 0.03, 0.04, 0.05, 0.06, 0.07, 0.08, or 0.09 mm, such as about 0.1, 0.2, 0.3, 0.4, 0.5, 0.6, 0.7, 0.8, or 0.9 mm, such as about 1, 1.1, 1.2, 1.3, 1.4, 1.5, 1.6, 1.7, 1.8, or 1.9 mm, such as about 2, 3, 4, 5, 6, 7, 8, or 9 mm, such as about 1, 2, 3, or 4 cm.

Bases in accordance with embodiments of the invention can have any suitable shape, having any number of edges. For example, in some embodiments, a base has a triangular shape, with three edges. In some embodiments, a base has a square shape, with four edges. In some embodiments, a base has a pentagonal shape, with five edges. In some embodiments, a base has a hexagonal shape, with six edges. As the number of edges of the base increases, the base approaches an approximately round, or circular geometry. For the avoidance of doubt, the term “plurality of wall segments”, as used herein, encompasses an embodiment wherein a base and/or a lid of a subject thermoplastic container comprises a round or oval geometry, and wherein the container comprises a wall segment that extends along the circumference of the round or oval geometry. Those of skill in the art will readily appreciate that a base or lid having any suitable number of edges, and any suitable shape, can be utilized in accordance with embodiments of the invention. In some embodiments, a base can comprise one or more folds, or fold lines, where the material of the base can be folded to provide enhanced mechanical properties to the container, or for aesthetic design purposes.

Thermoplastic containers in accordance with embodiments of the invention generally comprise a plurality of wall segments, equal in number to the number of edges on the base. As noted herein, where a base and/or a lid of a subject thermoplastic container comprises a round or oval geometry, the thermoplastic container can comprise a wall segment that extends along the circumference of the round or oval geometry. For the avoidance of doubt, such an embodiment is deemed to comprise a plurality of wall segments.

Wall segments in accordance with embodiments of the invention can have any suitable size and thickness, and are generally disposed in an orthogonal orientation with respect to the base in order to form the walls, or sides, of a thermoplastic container. Wall segments in accordance with embodiments of the invention are preferably square or rectangular in shape, but may also include other suitable geometries, depending on the design of a particular thermoplastic container. In some embodiments, a wall segment can comprise one or more ridges, indentations, or other features that provide desirable properties to the container, including, but not limited to, increased friction and graspability. In some embodiments, a wall segment can comprise one or more folds, or fold lines, where the material of the wall segment can be folded to provide enhanced mechanical properties to the container, or for aesthetic design purposes.

In some embodiments, a wall segment has a dimension that ranges from about 1 mm up to about 2 m, such as about 2, 3, 4, 5, 6, 7, 8, or 9 mm, or about 1, 2, 3, 4, 5, 6, 7, 8, or about 9 cm, or about 1, 2, 3, 4, 5, 6, 7, 8, or 9 dm, or about 1, 1.1, 1.2, 1.3, 1.4, 1.5, 1.6, 1.7, 1.8, or 1.9 m. Wall segments in accordance with embodiments of the invention can have a thickness that ranges from about 0.01 mm to about 5 cm, such as about 0.02, 0.03, 0.04, 0.05, 0.06, 0.07, 0.08, or 0.09 mm, such as about 0.1, 0.2, 0.3, 0.4, 0.5, 0.6, 0.7, 0.8, or 0.9 mm, such as about 1, 1.1, 1.2, 1.3, 1.4, 1.5, 1.6, 1.7, 1.8, or 1.9 mm, such as about 2, 3, 4, 5, 6, 7, 8, or 9 mm, such as about 1, 2, 3, or 4 cm.

Thermoplastic containers in accordance with embodiments of the invention can utilize any suitable combination of base dimensions and wall segment dimensions to form a container having a desired size and internal volume. For example, in some embodiments, a base has a larger dimension than the height of the wall segments, forming a container that is wider than it is tall. In other embodiments, a base has smaller dimensions than the height of the wall segments, forming a container that is taller than it is wide. In some embodiments, a base has a dimension that is the same as the height of the wall segments, thereby forming a container that is as wide as it is tall.

In some embodiments, a thermoplastic container comprises a lid. Lids in accordance with embodiments of the invention can have any suitable size and thickness, and are preferably disposed in an orthogonal position with respect to the wall segments in order to form a lid for a thermoplastic container. Lids in accordance with embodiments of the invention preferably have a geometry that closely mirrors the base of the thermoplastic container, depending on the design of a particular thermoplastic container. As the number of edges of the lid increases, the lid approaches an approximately round, or circular geometry. For the avoidance of doubt, the term “plurality of wall segments”, as used herein, encompasses an embodiment wherein a base and/or a lid of a subject thermoplastic container comprises a round or oval geometry, and where the container comprises a wall segment that extends along the circumference of the round or oval geometry. Those of skill in the art will readily appreciate that a base or lid having any suitable number of edges, and any suitable shape, can be utilized in accordance with embodiments of the invention. In some embodiments, a lid can comprise one or more folds, or fold lines, where the material of the lid can be folded to provide enhanced mechanical properties to the container, or for aesthetic design purposes.

In some embodiments, a lid has a dimension that ranges from about 1 mm up to about 2 m, such as about 2, 3, 4, 5, 6, 7, 8, or 9 mm, or about 1, 2, 3, 4, 5, 6, 7, 8, or about 9 cm, or about 1, 2, 3, 4, 5, 6, 7, 8, or 9 dm, or about 1, 1.1, 1.2, 1.3, 1.4, 1.5, 1.6, 1.7, 1.8, or 1.9 m. Lids in accordance with embodiments of the invention can have a thickness that ranges from about 0.01 mm to about 5 cm, such as about 0.02, 0.03, 0.04, 0.05, 0.06, 0.07, 0.08, or 0.09 mm, such as about 0.1, 0.2, 0.3, 0.4, 0.5, 0.6, 0.7, 0.8, or 0.9 mm, such as about 1, 1.1, 1.2, 1.3, 1.4, 1.5, 1.6, 1.7, 1.8, or 1.9 mm, such as about 2, 3, 4, 5, 6, 7, 8, or 9 mm, such as about 1, 2, 3, or 4 cm. In some embodiments, a lid can comprise one or more folds, or fold lines, where the material of the lid can be folded to provide enhanced mechanical properties to the container, and/or for aesthetic design purposes.

Lids in accordance with embodiments of the invention can be integrated with the thermoplastic container, for example, along one or all edges of the lid, or along at least a portion of one edge of the lid, so as to form a hinge that allows the lid to articulate between an opened and closed position with respect to the container. In some embodiments, a lid is completely separate from the thermoplastic container. Non-limiting examples of lid types include flush-type lids and plug-type lids, for example, as described in U.S. Pat. No. 3,301,464, the disclosure of which is herein incorporated by reference in its entirety. When such embodiments are employed, one or more wall segments of the thermoplastic container are suitably modified to facilitate engagement of the lid with the wall segments, as described, for example, in U.S. Pat. No. 3,301,464.

In some embodiments, a lid comprises a proximal end and a distal end. In certain embodiments, a proximal end of the lid comprises different elements than the distal end of the lid. For example, in some embodiments, the proximal end of the lid closely mirrors the geometry of the base of the thermoplastic container, for example, having a number of edges that matches the number of wall segments. In certain embodiments, a distal end of the lid contains a closure element similar to that of a milk carton, wherein folds of the thermoplastic material are used to create a liquid-impermeable closure.

In some embodiments, the distal end of the lid can include a cap. Suitable caps are generally known in the art, and can include standard features, such as a disc-shaped body and a depending skirt that can optionally comprise threading. In such embodiments, the distal end of the lid is suitably modified to engage with the cap, for example, by containing receptive threading. Optionally, any suitable cap liner or cap seal can be included. For example, a foam pressure seal, a foil heat induction seal, a LIFT ‘N’ PEEL™ heat induction liner, or a foam cap liner can readily be incorporated. Furthermore, any suitable safety seals and/or tamper resistant bands can readily be incorporated into a cap and/or lid in accordance with embodiments of the invention.

Aspects of the invention include troughs (e.g., base troughs (located within a base, or at an intersection of a base and a wall segment), wall troughs (located within a wall segment, or at an intersection of two wall segments), lid troughs (located within a lid, or at an intersection of a lid and a wall segment) that can be used to facilitate separation of the various components of the thermoplastic containers in order to allow them to preferably adopt a substantially flat configuration. Troughs in accordance with embodiments of the invention generally have a height (the distance from the floor, or bottom, of the trough to the top of the trough), a width (the distance between the first and second walls, or sides, of the trough), and a length. Troughs in accordance with embodiments of the invention can have any of a variety of cross-sectional shapes, including, for example, a U-shape, a V-shape, or a rectangular (e.g., square, or rectangular) shape.

Troughs in accordance with embodiments of the invention preferably have a height that ranges from about 0.01 mm to about 5 cm, such as about 0.02, 0.03, 0.04, 0.05, 0.06, 0.07, 0.08, or 0.09 mm, such as about 0.1, 0.2, 0.3, 0.4, 0.5, 0.6, 0.7, 0.8, or 0.9 mm, such as about 1, 1.1, 1.2, 1.3, 1.4, 1.5, 1.6, 1.7, 1.8, or 1.9 mm, such as about 2, 3, 4, 5, 6, 7, 8, or 9 mm, or such as about 1, 2, 3, or 4 cm. Troughs in accordance with embodiments of the invention preferably have a width that ranges from about 0.01 mm to about 5 cm, such as about 0.02, 0.03, 0.04, 0.05, 0.06, 0.07, 0.08, or 0.09 mm, such as about 0.1, 0.2, 0.3, 0.4, 0.5, 0.6, 0.7, 0.8, or 0.9 mm, such as about 1, 1.1, 1.2, 1.3, 1.4, 1.5, 1.6, 1.7, 1.8, or 1.9 mm, such as about 2, 3, 4, 5, 6, 7, 8, or 9 mm, or such as about 1, 2, 3, or 4 cm. Any suitable combination of trough height and width can be utilized. For example, in some embodiments, a trough has a height that is greater than its width, e.g., a trough that is deeper than it is wide. In some embodiments, a trough has a width that is greater than its height, e.g., a trough that is wider than it is deep. In some embodiments, a trough has a height and a width that are approximately equal, e.g., a trough that is as wide as it is deep.

Troughs in accordance with embodiments of the invention can also optionally include one or more elements configured to retain a separating component within a trough, as well as, optionally, one or more guide components configured to guide the path of a separating component along the length of the trough. In some embodiments, for example, a trough comprises one or two edges whose thickness is increased as compared to the thermoplastic material that makes up the floor, or bottom, of the trough. In some embodiments, a trough comprises one or two edges whose thickness is greater than the thickness of the thermoplastic material that makes up the floor, or bottom, of the trough by an amount that ranges from about 5% to about 500%, such as about 10%, 20%, 30%, 40%, 50%, 60%, 70%, 80%, 90%, 100%, 125%, 150%, 175%, 200%, 225%, 250%, 275%, 300%, 325%, 350%, 375%, 400%, 425%, 450%, or about 475%. In certain embodiments, a thickened trough edge, as described herein, can function as a retention component, as a guide component, or as both a retention component and as a guide component.

In some embodiments, a trough comprises one or two overhanging ledges that extend from an edge of the trough and project out over the center of the trough. In some embodiments, a trough ledge has a projection length that ranges from about 5% to about 40% of the width of the trough, such as about 10%, 15%, 20%, 25%, 30%, or about 35%. In some embodiments, a trough ledge has a thickness that ranges from about 0.01 mm to about 5 cm, such as about 0.02, 0.03, 0.04, 0.05, 0.06, 0.07, 0.08, or 0.09 mm, such as about 0.1, 0.2, 0.3, 0.4, 0.5, 0.6, 0.7, 0.8, or 0.9 mm, such as about 1, 1.1, 1.2, 1.3, 1.4, 1.5, 1.6, 1.7, 1.8, or 1.9 mm, such as about 2, 3, 4, 5, 6, 7, 8, or 9 mm, or such as about 1, 2, 3, or 4 cm. In some embodiments, a trough ledge runs an entire length of a trough, whereas in some embodiments, a trough ledge is only disposed along certain sections of a trough. In certain embodiments, a trough ledge, as described herein, can function as a retention component, as a guide component, or as both a retention component and as a guide component.

In some embodiments, a trough comprises one or more grooves, or a combination of grooves, that are disposed on one or both of the trough walls, and/or on the floor of the trough. In some embodiments, a groove has a depth that ranges from about 0.01 mm to about 1 cm, such as about 0.02, 0.03, 0.04, 0.05, 0.06, 0.07, 0.08, or 0.09 mm, such as about 0.1, 0.2, 0.3, 0.4, 0.5, 0.6, 0.7, 0.8, or 0.9 mm, such as about 1, 1.1, 1.2, 1.3, 1.4, 1.5, 1.6, 1.7, 1.8, or 1.9 mm, such as about 2, 3, 4, 5, 6, 7, 8, or 9 mm. Grooves in accordance with embodiments of the invention can have any suitable cross sectional geometry, including, without limitation, U-shaped, V-shaped, rectangular (e.g., square), or irregular cross sectional geometries. In some embodiments, a groove, or combination of grooves, runs an entire length of a trough, whereas in certain embodiments, a groove, or combination of grooves, is only disposed along certain sections of a trough. In some embodiments, a groove, or a combination of grooves, as described herein, can function as a retention component, as a guide component, or as both a retention component and as a guide component.

Aspects of the invention include angular wall components that are disposed at various locations within the subject thermoplastic containers. As described above, angular wall components in accordance with embodiments of the invention preferably comprise two substantially planar features that are contiguous, and that are oriented at an angle to one another. In some embodiments, the two substantially planar features of an angular wall component form an angle that ranges from about 180° to about 10°, such as about 175°, 170°, 165°, 160°, 155°, 150°, 145°, 140°, 135°, 130°, 125°, 120°, 115°, 110°, 105°, 100°, 95°, 90°, 85°, 80°, 75°, 70°, 65°, 60°, 55°, 50°, 45°, 40°, 35°, 30°, 25°, 20°, or about 15°. In some embodiments, an angular wall component is disposed within a wall segment. In some embodiments, an angular wall component is disposed at the junction of two adjacent wall segments. In certain embodiments, an angular wall component is disposed within a base. In certain embodiments, an angular wall component is disposed within a lid.

In some embodiments, an angular wall component comprises a guide component that is configured to guide the integrated separating component to separate the thermoplastic container along the length of the angular wall component, e.g., along the ridge that is formed at the point where the two substantially planar features meet and form an angle. Such guide components can comprise, for example, a thickened region of a wall segment on either side of the ridge that guides the motion of the integrated separating component along the ridge of the angular wall component. In some embodiments, a guide component comprises a raised projection that extends from a wall segment in a direction that is perpendicular to at least one of the substantially planar features of the angular wall component, and that guides the motion of the integrated separating component along the ridge of the angular wall component. In certain embodiments, a raised projection extends outwardly by a distance that ranges from about 0.1 mm to about 5 mm, such as about 0.2, 0.3, 0.4, 0.5, 0.6, 0.7, 0.8, 0.9, 1.0. 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, or about 4.9 mm. Guide components in accordance with embodiments of the invention can comprise any suitable geometry, such as square, rectangular, rounded, etc.

In some embodiments, an angular wall component comprises a thermoplastic material that is different from the thermoplastic material of one or more other parts the thermoplastic container, e.g., the base, wall segments, and/or the lid. In some embodiments, an angular wall component comprises a thermoplastic material that is the same as the thermoplastic material of one or more other parts the thermoplastic container, e.g., the base, wall segments, and/or the lid. In some embodiments, an angular wall component comprises a thermoplastic material that comprises one or more different mechanical properties from the thermoplastic material of one or more other parts the thermoplastic container, e.g., the base, wall segments, and/or the lid.

Aspects of the invention include rupture seams that are disposed at various locations within the subject thermoplastic containers. Rupture seams in accordance with embodiments of the invention are configured to rupture, or separate, in an irreversible manner when a particular force is applied to them. In some embodiments, an integrated separating component is configured to apply a suitable force that can rupture that rupture seam.

In some embodiments, a rupture seam comprises optical (e.g., color) properties that indicate its position to a user. For example, in some embodiments, a rupture seam comprises a material that is a different color than the material of the container. In some embodiments, a rupture seam comprises a translucent or transparent material that allows a user to visualize the contents of the container and/or the fill level of the container.

In some embodiments, a rupture seam can comprise a material having one or more mechanical properties that facilitate separation of the container. For example, in some embodiments, a rupture seam can comprise a geometry (e.g., a reduced thickness) that facilitates separation of the container. In some embodiments, a rupture seam is made from the same material that the remainder of the container is made from, but due to the geometry of the rupture seam (e.g., reduced thickness), the container is configured to separate along the rupture seam when a suitable force is applied. In some embodiments, a rupture seam comprises a material that is different from the material that makes up the rest of the container. In some embodiments, the material of the rupture seam has different mechanical properties than the material that makes up the rest of the container, and the different mechanical properties of the rupture seam material facilitate separation of the container along the rupture seam. In some embodiments, the joining of the rupture seam material to the rest of the container (i.e., the process of creating the container and rupture seam, from either the same material, or from two or more different materials) facilitates separation of the container. For example, in some embodiments, a container is produced using a two-shot, co-injection molding procedure, where a first material is injected into a mold to form the majority of the container, and a second material is injected into the mold to form the rupture seam(s). The junction between the rupture seam material and the container material is configured to separate when a suitable force is applied.

In certain embodiments, a rupture seam comprises a relatively long, narrow indentation that is configured to separate along the length of the indentation when appropriate force is applied.

Rupture seams in accordance with embodiments of the invention can have any suitable permeability (e.g., permeable or impermeable to air, permeable or impermeable to liquid), geometry (e.g., symmetric or asymmetric), material properties (e.g., optical properties), mechanical properties, rupture strength, or any combination thereof.

In some embodiments, a rupture seam comprises a relatively long, narrow indentation, and two sides that come together to form the rupture seam. In certain embodiments, a rupture seam comprises a symmetric geometry, wherein both sides of the rupture seam are identical on either side of the axis of the rupture seam. In certain embodiments, a rupture seam comprises an asymmetric geometry, wherein the sides of the rupture seam are not identical on either side of the axis of the rupture seam.

In some embodiments, a rupture seam is configured to generate a blunt edge after it has been separated. For example, in some embodiments, a rupture seam comprises an asymmetric geometry, similar to a zipper, wherein a plurality of teeth are positioned on either side of the rupture seam. In use, the integrated separating component passes along the rupture seam and separates the teeth, thereby opening the rupture seam and generating a blunt edge on each side of the rupture seam. This blunt edge can help prevent a user from cutting him or herself on the separated thermoplastic container by reducing the number of, or eliminating altogether, any sharp edges resulting from the separation process.

Rupture seams in accordance with embodiments of the invention can have any suitable permeability. For example, in some embodiments, a rupture seam is impermeable to liquid. In some embodiments, a rupture seam is impermeable to air. In some embodiments, a rupture seam is permeable to liquid. In some embodiments, a rupture seam is permeable to air. One of ordinary skill in the art can readily select an appropriate permeability for a rupture seam based on the particular application of the thermoplastic container. For example, if a thermoplastic container is to be used to store a liquid, then the rupture seam chosen can be impermeable to liquid and air. If a thermoplastic container is to be used to store a solid material that requires ventilation, then the rupture seam chosen can be permeable to air to allow the appropriate level of breathability for the thermoplastic container.

Aspects of the invention include a rupture seam underlay that comprises a flap of material that is disposed along one or both sides of a rupture seam, and that substantially covers at least a portion the rupture seam. Rupture seam underlays in accordance with embodiments of the invention play a protective role in that they can protect a rupture seam from, e.g., becoming caked with debris, rupturing at an undesirable time or under undesirable conditions. Rupture seam underlays also play a role in modulating the permeability of a rupture seam in a desirable manner. For example, in some embodiments, a rupture seam can be permeable to air, and a rupture seam underlay can be impermeable to air. When the user wants the contents of the thermoplastic container to be ventilated, he or she can retract the rupture seam underlay, thereby exposing the rupture seam to the environment, and allowing the contents of the thermoplastic container to be ventilated.

Rupture seam underlays in accordance with embodiments of the invention can be made from any suitable material, can have any suitable permeability, and can have any suitable geometry. For example, in some embodiments, a rupture seam underlay comprises a material that is the same as the material of the thermoplastic container. In some embodiments, a rupture seam underlay comprises a material that is different from the material of the thermoplastic container. In some embodiments, a rupture seam underlay comprises a thermoplastic material that comprises one or more different mechanical properties from the thermoplastic material of one or more other parts the thermoplastic container.

In some embodiments, a rupture seam underlay is impermeable to liquid. In some embodiments, a rupture seam underlay is impermeable to air. In some embodiments, a rupture seam underlay is permeable to liquid. In some embodiments, a rupture seam underlay is permeable to air. One of ordinary skill in the art can readily select an appropriate permeability for a rupture seam underlay based on the particular application of the thermoplastic container. For example, if a thermoplastic container is to be used to store a liquid, then the rupture seam underlay chosen can be impermeable to liquid and air. If a thermoplastic container is to be used to store a solid material that requires ventilation, then the rupture seam underlay chosen can be permeable to air to allow the appropriate level of breathability for the thermoplastic container.

Rupture seam underlays in accordance with embodiments of the invention are preferably disposed on one or both sides of a rupture seam, and can be positioned on one or both sides (e.g., on an external side and/or on an internal side) of a thermoplastic container. Rupture seam underlays preferably comprises a base, or contact point, where they are connected to the thermoplastic container, and an extension component that extends away from the base to cover the rupture seam. In certain embodiments, an extension component of a rupture seam underlay is longer than the width of a rupture seam, so that the extension component of the rupture seam underlay covers the entire rupture seam, plus some additional portion of the thermoplastic container on the opposite side of the rupture seam from the base of the rupture seam underlay. In some embodiments, a rupture seam underlay is shorter than the width of the rupture seam, and only covers a portion of the rupture seam. In certain embodiments, two rupture seam underlays can be positioned on either side of a rupture seam, and the rupture seam underlays are configured to overlap with one another to cover the entire rupture seam.

In some embodiments, an extension portion of a rupture seam underlay has a length that ranges from about 1 mm to about 10 mm, such as about 2, 3, 4, 5, 6, 7, 8 or 9 mm. In some embodiments, a rupture seam underlay has a thickness that ranges from about 0.01 mm to about 5 cm, such as about 0.02, 0.03, 0.04, 0.05, 0.06, 0.07, 0.08, or 0.09 mm, such as about 0.1, 0.2, 0.3, 0.4, 0.5, 0.6, 0.7, 0.8, or 0.9 mm, such as about 1, 1.1, 1.2, 1.3, 1.4, 1.5, 1.6, 1.7, 1.8, or 1.9 mm, such as about 2, 3, 4, 5, 6, 7, 8, or 9 mm, such as about 1, 2, 3, or 4 cm.

As noted above, rupture seam underlays in accordance with embodiments of the invention can be retractable. In some embodiments, a rupture seam underlay can be retracted by a user at will. For example, when desired, a user can retract the rupture seam underlay, and can also move the rupture seam underlay back into position covering the rupture seam. In certain embodiments, a rupture seam underlay is configured to retract from the rupture seam when the rupture seam underlay comes into contact with the integrated separating component. For example, in some embodiments, the integrated separating component is configured to retract the rupture seam underlay(s) from the rupture seam when the integrated separating component is passed along the rupture seam.

Aspects of the invention include direction-changing components that are configured to change the direction in which a separation component is traveling. In some embodiments, a direction-changing component is configured to change a travel direction of a separating component in an orthogonal manner, wherein the separating component, upon passing through the direction-changing component, moves from a first plain to a second plain. In some embodiments, a direction-changing component is configured to change a travel direction of a separating component in an orthogonal manner, wherein the separating component, upon passing through the direction-changing component, moves from a first heading to a second, orthogonal heading, while staying within the same plain. In some embodiments, a direction-changing component is configured to change a travel direction of a separating component in a non-orthogonal manner.

Direction-changing components in accordance with embodiments of the invention can comprise any combination of troughs, grooves, angular wall components, rupture seams, retention components, and/or guide components, as described herein, wherein these elements are configured to facilitate a suitable change in the travel direction of the separation component. Direction-changing components in accordance with embodiments of the invention are generally disposed at a junction (e.g., a junction location) between two or more elements, e.g., at a junction between a base trough and a wall trough, at a junction between a wall trough and a lid trough, at a junction between a first angular wall component and a lid trough, etc. Direction-changing components can also be located, e.g., at an intersection of two base troughs, two wall troughs, two lid troughs, two angular wall components, two rupture seams, or any combination thereof. In certain embodiments, a junction location can be a corner where two or more elements meet (e.g., a wall segment and a base segment). In some embodiments, a direction-changing component can be disposed within a single element (e.g., within a single wall segment), such that the travel heading (i.e., the direction of travel) of the integrated separating component changes when the integrated separating component passes through the direction-changing component.

### Separating Components

Aspects of the invention include separating components that are configured to separate two adjacent portions of a thermoplastic container, thereby allowing the container to adopt a substantially flat configuration. In some embodiments, a separating component is integrated into a thermoplastic container, whereas in some embodiments, a separating component is a separate element that is configured to work in an interoperable manner with a thermoplastic container. In certain embodiments, a separating component is configured to fit within a recessed area, or depression, on a thermoplastic container so as to be out of the way of the user of the container when the separating component is not in use. In some embodiments, a separating component is disposed within a recessed depression on the base of the container when not in use. In some embodiments, a separating component is disposed within a recessed depression in a wall segment of the container. In some embodiments, a separating component is disposed in a recessed depression in a lid of the container. In certain embodiments, a separating component is configured to separate two adjacent portions of a thermoplastic container by passing along one or more troughs, thereby separating the container in a defined, or prescribed manner, and causing the container to preferably adopt a substantially flat configuration.

In some embodiments, a separating component comprises a blade. Blades in accordance with embodiments of the invention can comprise any suitable material, such as plastic, metal, glass, or any combination thereof. In one preferred embodiment, a blade is made of recyclable plastic. In some embodiments, a blade is retractable, such that it can be extended from the separating component when in use, or retracted into a protected position within the separating component when not in use. In some embodiments, a separating component comprises a blade guard that is configured to allow the blade to contact the material of the container in order to affect a separation therein, while simultaneously preventing a user from inadvertently coming into contact with the blade.

In some embodiments, a separating component comprises a blade-engaging component that is configured to cause the blade to enter into a trough and puncture the material of the thermoplastic container within the trough to start the process of separating the thermoplastic container along the length of the trough. In certain embodiments, a blade-engaging component is configured to automatically engage the blade with a trough when the separating component is removed from the recessed depression.

In some embodiments, a separating component comprises a C-shaped component comprising a recessed area in the center of the C shape, wherein the blade is located within the recessed area. Positioning the blade in the recessed area helps to protect the user from coming into contact with the blade. In certain embodiments, the recessed area of the C-shaped component is configured to engage with one or more portions of the thermoplastic container. For example, in some embodiments, the C-shaped component is configured to engage with both an external side and an internal side of the thermoplastic container by having a geometry that is complementary to the geometry of the thermoplastic container.

In some embodiments, a separating component comprises a tear-initiating component that is configured to initiate a tear in the material of the thermoplastic container within a trough. In some embodiments, the separating component is configured to propagate the tear along the length of a trough. Tear-initiating components, in some embodiments, can be blade-like in nature, but are not required to contain a sharpened edge.

In some embodiments, a separating component comprises a pull tab that is configured to allow a user to grasp the separating component and to apply a force to the separating component. The force applied to the separating component is sufficient to either cause a blade in the separating component to cut the material of the thermoplastic container along the length of a trough, or to affect the initiation and propagation of a tear in the material of the thermoplastic container along the length of a trough. In certain embodiments, the pull tab comprises a ring having a suitable size for a user to engage one or more fingers with the ring to exert the desired amount of force.

In some embodiments, a separating component comprises a geometry that conforms to a cross-sectional geometry of a trough. For example, in some embodiments, a trough can have a U-shaped cross-sectional geometry, and the separating component can also have a U-shaped cross-sectional geometry so that the separating component is retained with the trough. In certain embodiments, as described herein, a trough can comprise, e.g., one or more retention components, such as one or more ledges extending from an edge of the trough, which serve to retain the separating component within the trough, and/or guide the separating component to travel in the direction of the length of the trough. Depending on the cross-sectional geometry of the troughs used in a particular thermoplastic container, a suitable and complimentary cross-sectional geometry can be selected for the separating component in order to ensure compatibility. In some embodiments, a separating component comprises a spherical shape that is configured to conform to a rounded, or U-shaped geometry of a trough. In such embodiments, the spherical separating component can travel in a non-linear direction along a trough, since its geometry does not constrain it to rectilinear movements. In certain embodiments, a trough has a non-linear trajectory, for example, containing one or more arcs, curves, corners, and/or other non-linear features, and a separating component, such as a spherically-shaped separating component, can traverse the trajectory of the trough along such features in a continuous manner.

In some embodiments, a separating component comprises one or more elements that conform to a cross-sectional geometry of a groove, or a combination of grooves. In certain embodiments, as described herein, a groove, or a combination of grooves, can serve as a retention component and/or as a guide component, which functions to retain the separating component within the trough, and/or guide the separating component to travel in the direction of the length of the trough. Depending on the cross-sectional geometry of a groove, or a combination of grooves, used in a particular trough, a suitable and complimentary cross-sectional geometry can be selected for the separating component in order to ensure compatibility.

In certain embodiments, an integrated separating component comprises a wedging component that comprises a blunt end and one or more inclined surfaces. In use, the wedging component is configured to convert a force applied to the blunt end into forces that are perpendicular to the one or more inclined surfaces. These forces can be applied to the teeth of a rupture seam, thereby separating the teeth and opening the rupture seam in the same way that a zipper fastener separates the teeth of a zipper.

Aspects of the invention further include one or a plurality of integrated separating components configured to irreversibly separate the container into one or more component parts of a predetermined configuration. In addition, it should be noted that the integrated separating component(s) are such that that they do not adversely influence the container's ability to contain a given liquid or solid medium. Accordingly, the shelf life of the container herein is not otherwise adversely influenced by the presence of the integrated separating component(s) which now provide a user the convenience of reconfiguring the container into a geometric form that is relatively more amenable to plastic recycling operations along with improved shipping/storing capability.

### Materials

The subject thermoplastic containers and components thereof (e.g., caps), can be constructed from any suitable thermoplastic material, preferably from a recyclable thermoplastic material. Recyclable thermoplastic materials are generally known in the art, and include, without limitation, petroleum-based plastics and bioplastics. Non-limiting examples of petroleum-based plastics include: polyethylene terephthalate (PET), high-density polyethylene (HDPE), polyvinyl chloride (PVC), low-density polyethylene (LDPE), linear low density polyethylene (LLDPE), medium density polyethylene (MDPE), metallocene based polyethylene (mPE), polypropylene (PP), polystyrene (PS), acrylic, polycarbonate, copolymers of any such resins, or any combination thereof, or any equivalents thereof. Non-limiting examples of bioplastics include: starch-based plastics, cellulose-based plastics, protein-based plastics, lipid-based plastics, or any combination thereof. Any suitable thermoplastic material or combination of suitable thermoplastic materials, or any equivalents thereof, can be used to construct the subject thermoplastic containers.

In some embodiments, a thermoplastic container as described herein, including all components thereof, is made entirely of the same material. In some embodiments, a thermoplastic container comprises two or more different materials. For example, in one embodiment, a thermoplastic container is made from a first material, and the cap is made from a second, different material; in one embodiment, a wall segment is made from a first material, and a wall trough is made from a second, different material. In certain embodiments, two or more different portions of a thermoplastic container can contain the same material, but the material can have different mechanical properties in each different portion of the container. For example, in some embodiments, the base, wall segment and lid of a container comprise a first material having a first mechanical property, e.g., a first fracture toughness value, and the troughs of the thermoplastic container also comprise the first material, but have a second, different mechanical property, e.g., a second fracture toughness value.

In some embodiments, a separating component is made from a material that is different from the material that constitutes the remainder of the thermoplastic container. For example, in one embodiment, a thermoplastic container is made of a first material, and a separating component is made of a second, different material. In certain embodiments, both the first material and the second material are recyclable.

In certain embodiments, one or more components of the subject thermoplastic containers comprise a degradable material, a biodegradable material, a compostable material, or any combination thereof. Non-limiting examples of such materials include: polyhydroxyalkanoate (PHA); polylactic acid (PLA); cellulose acetate (CA); starch (e.g., corn, potato, tapioca, etc.); cellulose; soy protein; polybutylene succinate (PBS); polycaprolactone (PCL); polybutyrate adipate terephthalate (PBAT); and polyvinyl alcohol (PVA).

### Methods of Manufacture

Thermoplastic containers in accordance with embodiments of the invention can be manufactured using any of a variety of suitable manufacturing techniques, including, but not limited to, thermoforming, blow molding, injection molding, compression molding or additive manufacturing.

Thermoforming broadly covers a number of processes such as vacuum forming, billow forming, plug assist vacuum forming and pressure forming. Matched die molding is similar in many ways, and is sometimes referred to as thermoforming if it involves the process of heating a sheet of material. Blow molding is also a broad process term, and includes extrusion blow molding, injection-stretch blow molding, stretch blow molding, or accumulator blow molding. Additive manufacturing, also referred to as 3D printing, is a rapidly evolving process that uses computer-aided-design (CAD) software or 3D object scanners to direct hardware to deposit material, layer upon layer, in precise geometric shapes. As its name implies, additive manufacturing adds material to create an object. By contrast, when an object is created by traditional means, it is often necessary to remove material through milling, machining, carving, shaping or other means. Injection molding and co-injection molding processes involve the injection of molten material(s) into a mold, where they solidify to produce an object. All of the processes listed above can be adapted for use with a single material, or can be adapted to utilize multiple materials.

For example, thermoforming processes can be utilized multi-layer films or sheets, or monolayer sheets, depending on the particular application. Injection molding processes can also use multiple materials. For example, co-injection molding processes can be used to produce multi-layer products over most of the product surface area. Multi-shot injection molding processes (e.g., 2 shot molding) use two materials which are “adjacent” to one another at selected locations. The use of the second material allows for the control of tear forces based on both the cohesive (internal) strength of the second material and the adhesive strength between the two different materials, either or both of which properties can be tuned to achieve one or more desired characteristics of a container produced therefrom.

Blow molding processes can also be used to produce objects comprising single or multiple materials. For example, extrusion blow molding can utilize a single material or multi-materials. A co-extrusion blow molded container could be “multi-layer”, having an inner layer over most or all of the surface area of the container. In some embodiments, a second material could be deposited in the form of stripes. In some embodiments, such stripes can have different material properties, such as, e.g., different optical properties (for example in the case of an oil bottle containing transparent stripes that allow visualization of the liquid level in the container), or different mechanical properties (for example, the ability to tear more easily than the material that makes up the majority of the container).

Additive manufacturing processes can also be single material or multi-material processes. For example, aspects of the invention relate to thermoplastic containers wherein the integrated separating component is produced by integrating a separating component into a homogenous single material for the container, or by producing the separating component from a second material.

### Systems

Aspects of the invention include systems comprising various components of the subject thermoplastic containers. In some embodiments, a system comprises a thermoplastic container comprising a base comprising a plurality of edges along its perimeter, a plurality of wall segments extending orthogonally from each edge of the base, and a separating component configured to separate the thermoplastic container, thereby allowing the thermoplastic container to adopt a substantially flat configuration. In some embodiments, a thermoplastic container further comprises at least one trough, angular wall component, or rupture seam, disposed within a wall segment of the thermoplastic container, and at least one trough, angular wall component, or rupture seam disposed between a first edge of the base and a wall segment, and the separating component is configured to separate the thermoplastic container along troughs, angular wall components, or rupture seams, thereby allowing the thermoplastic container to adopt a substantially flat configuration.

As reviewed herein, in some embodiments, a separating element is integrated into the thermoplastic container. In some embodiments of the subject systems, a separating component is a separate element, and is configured to be introduced into the material of the thermoplastic container, and to separate the material of the thermoplastic container, e.g., along at least one trough, angular wall component, or rupture seam. In some embodiments, a separating component is disposed within a stand-alone apparatus, and the apparatus is configured to receive a thermoplastic container within a receptacle. Once the thermoplastic container has been placed within the receptacle, the apparatus can be operated to separate the thermoplastic container, e.g., along one or more troughs, angular wall components, or rupture seams, thereby causing the thermoplastic container to adopt a substantially flat configuration.

### Methods

Aspects of the invention include methods for converting (e.g., unfolding) a thermoplastic container from a three dimensional configuration to a substantially flat configuration. In some embodiments, the methods involve engaging a separating component, as described herein, with the material of a thermoplastic container, as described herein, so that the separating component initiates a separation in the material of the thermoplastic container. In some embodiments, the separation in the material is located within a trough, along an angular wall component, or along a rupture seam, or any combination thereof, as described herein. In some embodiments, the methods further involve applying a force to a pull tab on the separating component, thereby causing the separating component to move along the length of a trough, an angular wall component, or a rupture seam, or any combination thereof, and to separate the material of the thermoplastic container along the length of the trough, the angular wall component, or the rupture seam, or any combination thereof. In certain embodiments, the methods involve passing the separating component through one or more direction-changing components to transition the separating component from a first trough, angular wall component, or rupture seam to a second trough, angular wall component, or rupture seam.

In some embodiments, the methods involve completely separating a portion of the thermoplastic container from a remainder of the thermoplastic container. For example, in some embodiments, the methods involve passing the separating component along an entire perimeter of a lid or a base, thereby separating the lid or the base from the remainder of the material that constitutes the container. In some embodiments, this method provides a separation of different materials that are used to make the majority of the thermoplastic container (e.g., the wall segments) from specific material(s) that are used to make, e.g., the cap. By separating the cap and a portion of the lid from the remainder of the thermoplastic container, the user is able to recycle these two separate components in different ways. For example, if the material that makes up the base and wall segments is a compostable material, and the material that makes up the cap is not compostable, then the base and wall segments can be placed in a compost bin, while the cap can be placed in a standard (non-compostable) plastic recycling bin.

In some embodiments, the methods involve only partially separating a portion of the thermoplastic container from the remainder of the container, thereby allowing the container to adopt a substantially flat configuration, while still maintaining an attachment between some components of the container. For example, in some embodiments, the methods involve passing a separating component along three edges of a square-shaped base, thereby separating three sides of the base from their adjacent wall segments, but leaving one edge of the base connected to its adjacent wall segment, resulting in a container with a substantially flat configuration, with the base attached to the wall segments along only one edge of the base, forming a hinge-like connection between the base and the attached wall segment.

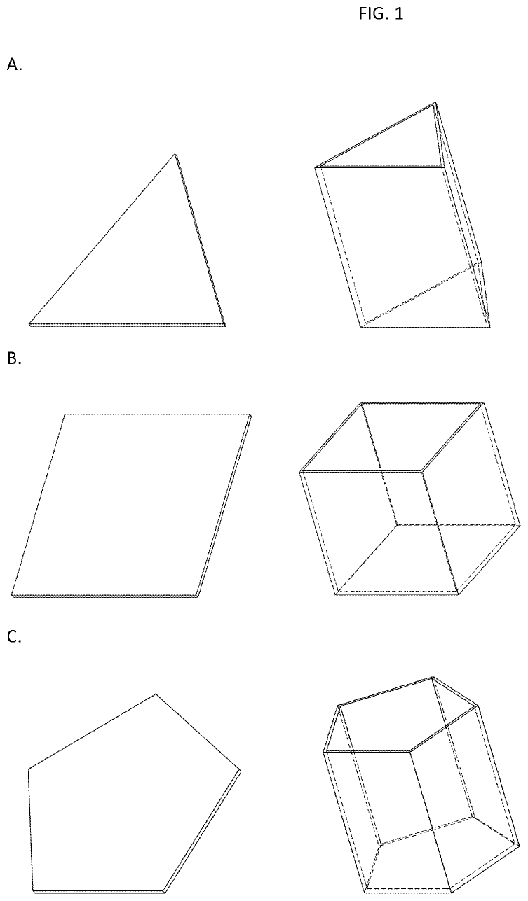

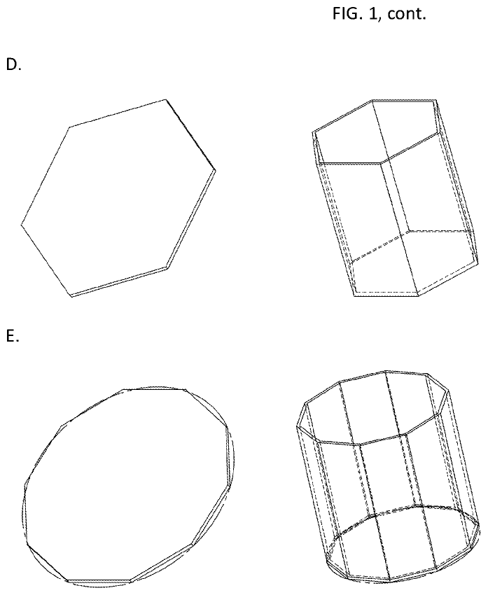

Turning now to the figures, FIG. 1 depicts of variety of different bases that can be utilized in the subject thermoplastic containers. Panel A shows a triangular base having three edges. Panel B shows a square base having four edges. Panel C shows a pentagonal base having 5 edges. Panel D shows a hexagonal base having six edges. Panel E demonstrates that as the number of edges on a base increases, the shape of the base approaches a circle. Also illustrated in FIG. 1 are three-dimensional representations of a container comprising the above-described base geometries. Notably, as the number of sides of the container increases, the geometry approaches a round, or circular shape. In some embodiments, a container comprises a round or oval base, and a cylindrical or ovoid three-dimensional shape when formed into a container in accordance with embodiments of the invention.

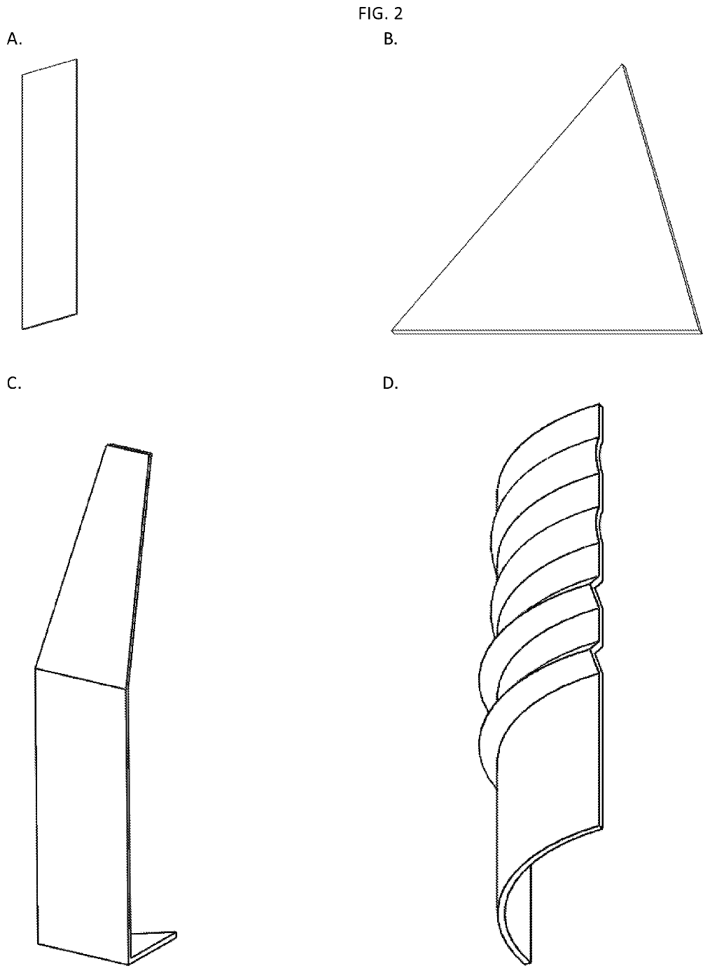

FIG. 2 depicts a variety of wall segments that can be utilized in the subject thermoplastic containers. Panel A depicts a long, rectangular wall segment. Panel B depicts a triangular wall segment. Panel C depicts two wall segments, the upper segment having a trapezoidal geometry and the lower segment having a rectangular geometry, as well as a portion of a base. Panel D depicts a cylindrical wall segment comprising a plurality of ridges, or other features configured to provide increased friction and graspability to a thermoplastic container.

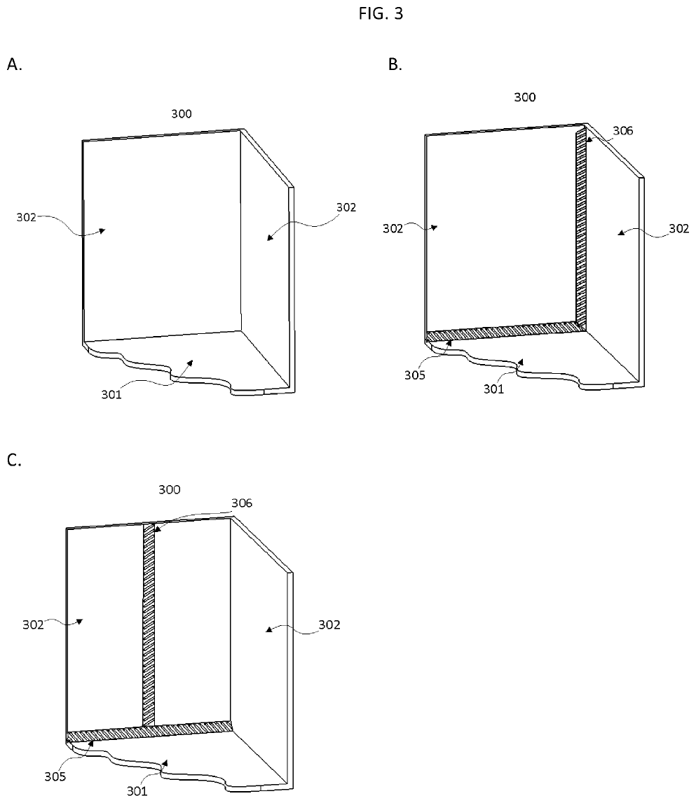

FIG. 3, Panel A depicts a partial assembly 300 comprising a base 301, and two wall segments 302. In Panel B, the partial assembly 300 comprises a base 301, two wall segments 302, a base trough 305 disposed between an edge of the base 301 and an adjacent wall segment 302, and a wall trough 306 disposed between two adjacent wall segments 302. In Panel C, the partial assembly 300 comprises a base 301, two wall segments 302, a base trough 305 disposed between an edge of the base 301 and an adjacent wall segment 302, and a wall trough 306 disposed within a single wall segment 302.

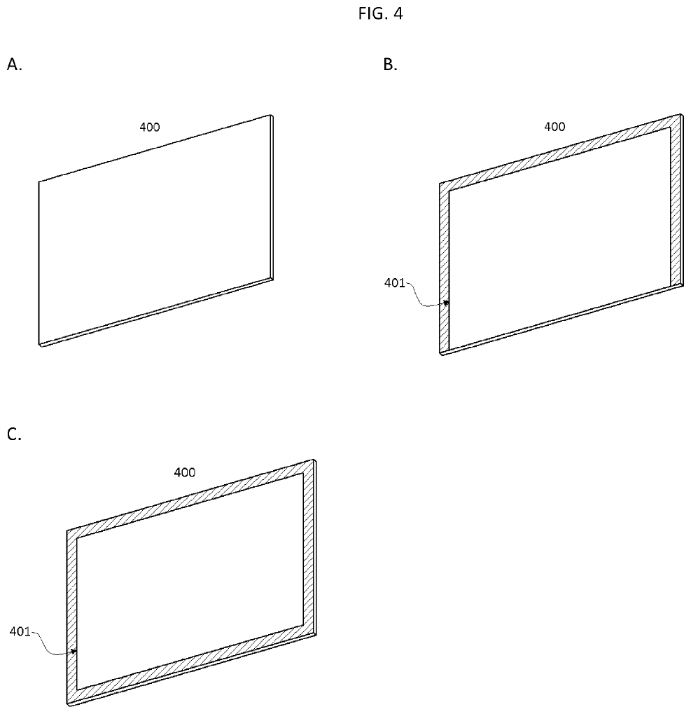

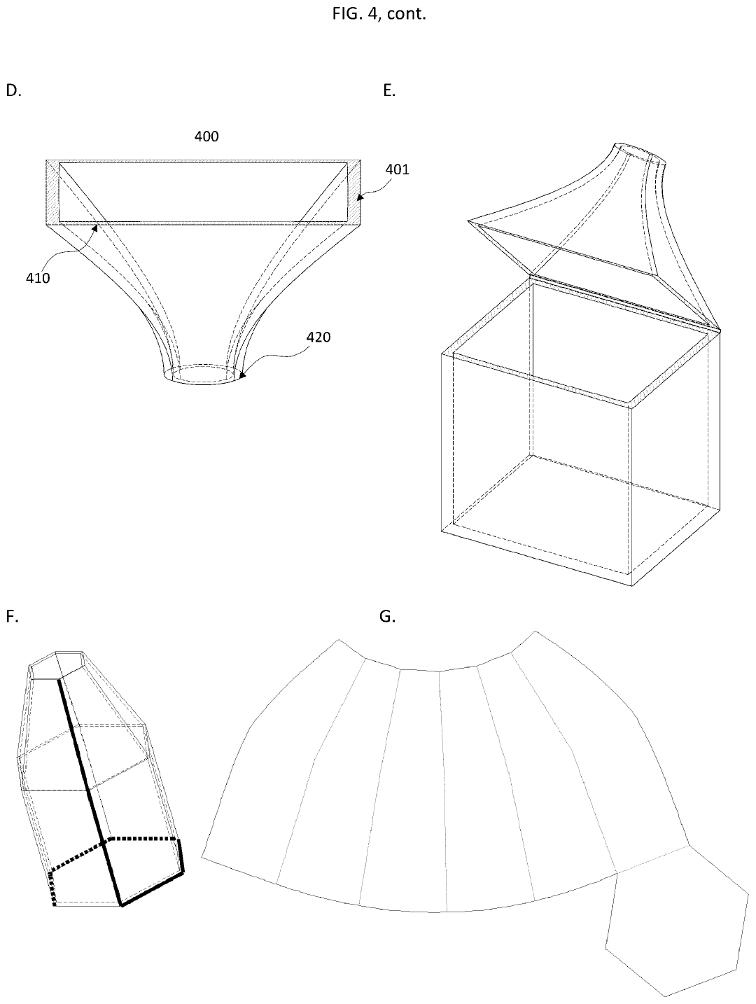

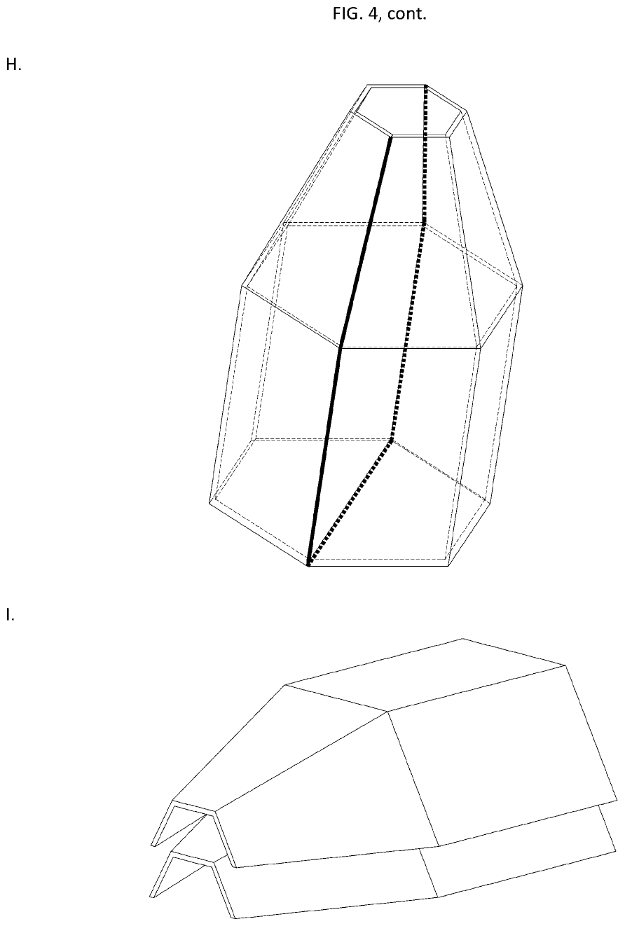

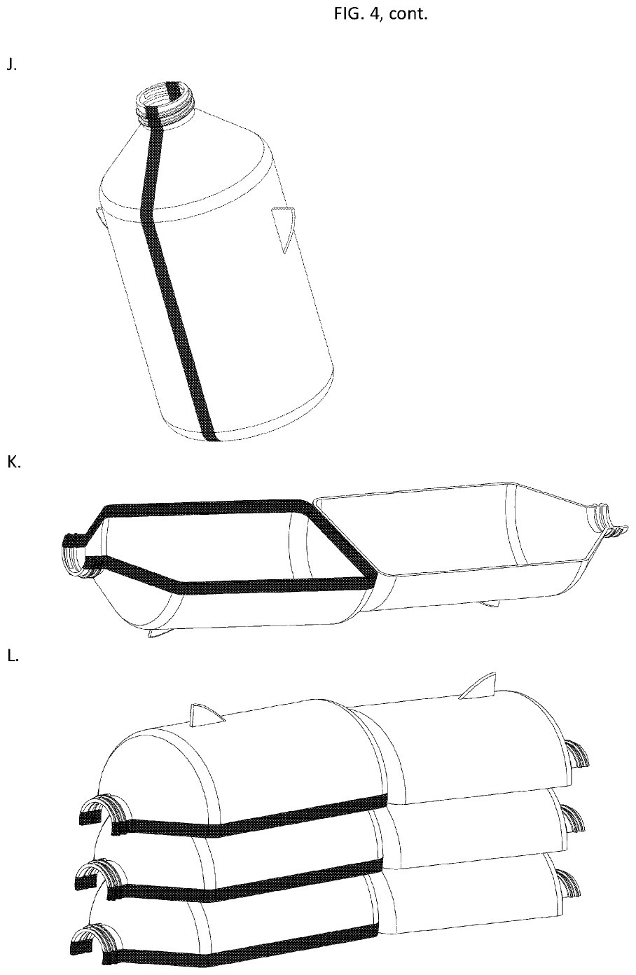

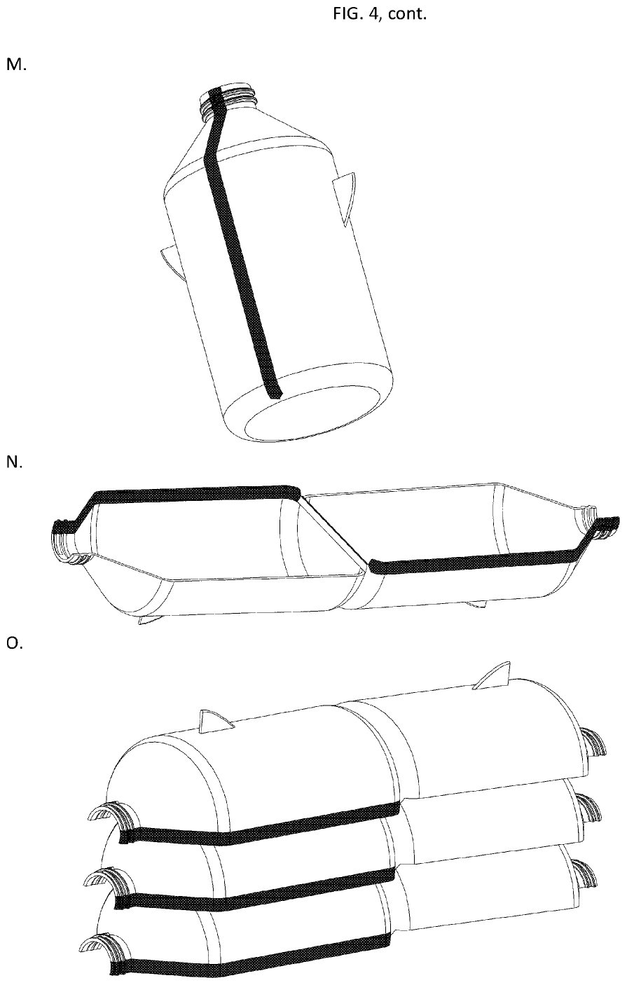

FIG. 4 depicts a variety of thermoplastic containers in accordance with embodiments of the invention. Panel A depicts a rectangular lid 400 comprising four edges. Panel B depicts a rectangular lid 400 comprising four edges and three lid troughs 401 disposed along three edges of the lid. Panel C depicts a rectangular lid 400 comprising four edges and four lid troughs 401 disposed along all four edges of the lid. Panel D depicts a lid 400 comprising a proximal end 410 and a distal end 420. The depicted lid 400 comprises four lids troughs 401, each disposed along an edge of the lid 400. Panel E shows the lid depicted in panel D attached to a container with a rectangular cross-sectional geometry, wherein the lid is hingedly connected to the container along one edge.

FIG. 4, panel F shows a six-sided (hexagonal) container in accordance with one embodiment of the invention. In the depicted embodiment, a rupture seam or trough is present, passing along an angular wall component from the top of the container to the base. At the junction of the base and the lower wall segments, the rupture seam or trough turns 90 degrees and then traverses five edges of the base. In use, the container depicted in FIG. 4, panel F is separated along the depicted rupture seam or trough, and the container is then transitioned from a three-dimensional configuration to a substantially flat configuration. Panel G shows the container depicted in panel F after it had been transitioned into a substantially flat configuration by separating the container along the rupture seam or trough using an integrated separating component.

FIG. 4, panel H shows a six-sided container in accordance with one embodiment of the invention. In the depicted embodiment, a rupture seam or trough is present, passing along the entire circumference of the container's longitudinal axis. In some embodiments, the depicted rupture seam is created using a co-extrusion blow molding process. In use, the depicted container is separated along the rupture seam or trough to create two separate pieces. In some embodiments, as depicted in panel I, the two separate pieces are stackable.

FIG. 4, panel J shows a container in accordance with one embodiment of the invention. In the depicted embodiment, a rupture seam or trough is present, passing along the entire circumference of the container's longitudinal axis. In some embodiments, the depicted rupture seam is created using a co-extrusion blow molding process. Also depicted are two pull tabs positioned on opposite sides of the container, and oriented to provide a user with leverage to separate the container along the rupture seam or trough. In use, the depicted container is separated along the rupture seam or trough, causing the two sides of the container to splay outward, as depicted in panel K. The rupture seam or trough in the base of the depicted embodiment is configured to form a hinge, allowing the two parts of the container to splay outward, folding along the hinge, after the container has been separated along the rupture seams or troughs. In some embodiments, as depicted in panel L, the splayed open containers are stackable.

FIG. 4, panel M, shows a container in accordance with one embodiment of the invention. In the depicted embodiment, two rupture seams or troughs are present, each traversing the container from the top to the base along the wall segments, and each positioned on opposite sides of the container. In some embodiments, the depicted rupture seam is created using a co-extrusion blow molding process. Also depicted are two pull tabs positioned on opposite sides of the container, and oriented to provide a user with leverage to separate the container along the rupture seam or trough. In use, the depicted container is separated along the rupture seams or troughs, causing the two sides of the container to splay outward, as depicted in panel N. In the depicted embodiment, the base of the container is flexible enough that the two sides of the container can splay outward even when no groove or indentation is present in the base. In some embodiments, as depicted in panel O, the splayed open containers are stackable.

In some embodiments, a rupture seam or trough as depicted in FIG. 4 is created using a co-extrusion blow molding process. In use, the depicted container is separated along the rupture seam or trough to create two separate pieces, or two pieces that are hingedly connected to each other. In certain embodiments, a container comprises at last two pull tabs that are positioned on opposite sides of the container from one another, and are configured to allow a user to pull on the pull tabs to assist with separating the container along the rupture seam or trough.

FIG. 5 depicts a thermoplastic container in a three-dimensional configuration, and in various stages in the process of transitioning from a three-dimensional configuration to an unfolded, two-dimensional configuration. In Panel A, the thermoplastic container 500 is depicted in a three-dimensional configuration. The thermoplastic container 500 comprises a base 301, four wall segments 302, a lid 400, three base troughs 305, one wall trough 306, and three lid troughs 401. In Panel B, the thermoplastic container has been separated along two wall troughs, and along one lid trough, resulting in the thermoplastic container having one open end. In Panel C, the thermoplastic container has been separated along three wall troughs, and along two lid troughs, resulting in the thermoplastic container having one open end and one open side, with the lid segment attached to an adjacent wall segment. In Panel D, the thermoplastic container has been separated along four wall troughs, and three lid troughs, resulting in the thermoplastic container adopting a substantially flat configuration.

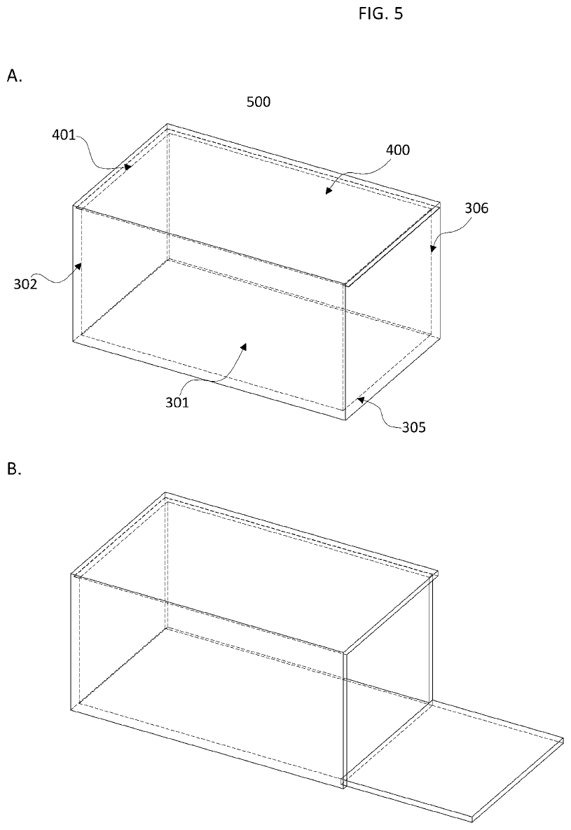

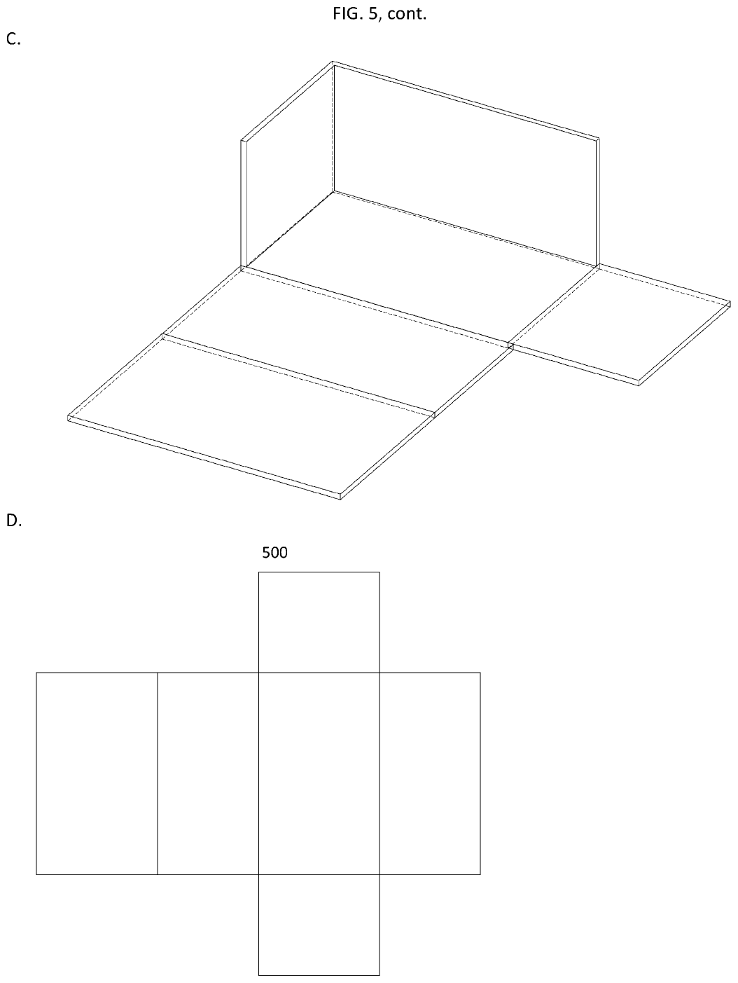

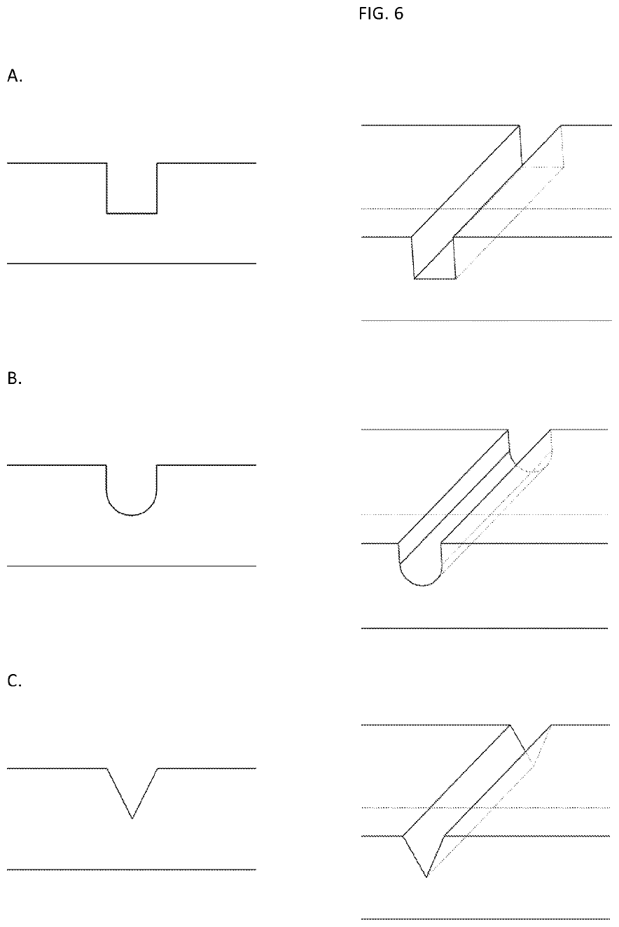

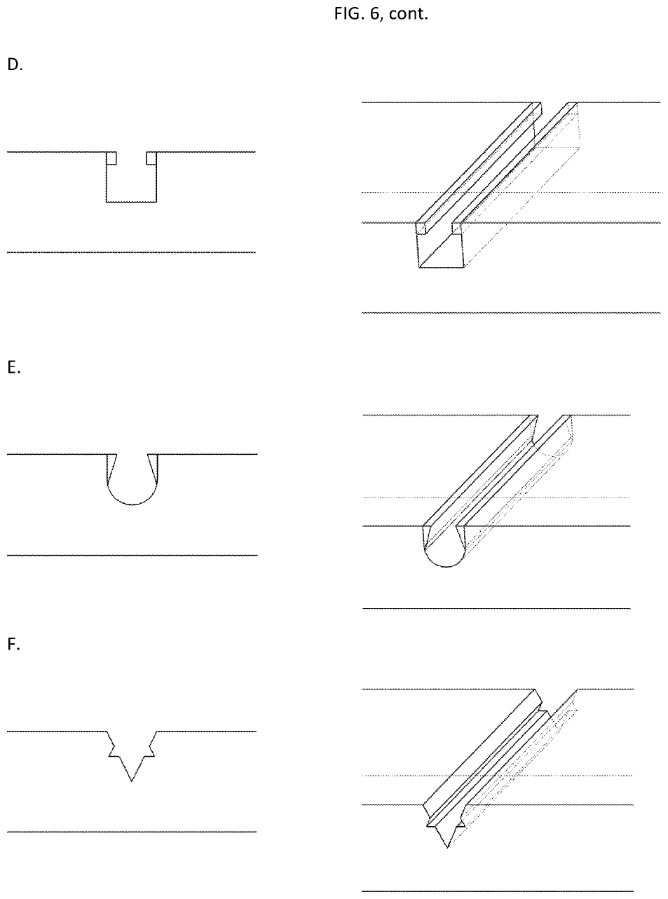

FIG. 6 depicts a variety of troughs, guide components, and retention components that can be utilized in the subject thermoplastic containers. Panel A is a cross-sectional view of a trough having a rectangular shape, as well as a perspective view. Panel B is a cross-sectional view of a trough having a U-shape, as well as a perspective view. Panel C is a cross-sectional view of a trough having a V-shape, as well as a perspective view. Panel D is a cross-sectional view of a trough having a rectangular shape, and having two projecting ledges that extend from the edges of the trough, as well as a perspective view. The depicted projecting ledges can serve as guide components, as retention components, or as both guide components and retention components. Panel E is a cross-sectional view of a trough having a U-shape, as well as a perspective view, and comprising a thickened trough edge that can serve as a guide component, as a retention component, or as both a guide component and a retention component. Panel F is a cross-sectional view of a trough having a V-shape, as well as a perspective view. The depicted trough also comprises two V-shaped grooves disposed in the walls of the trough. The depicted grooves can serve as a guide component, as a retention component, or as both a guide component and a retention component.

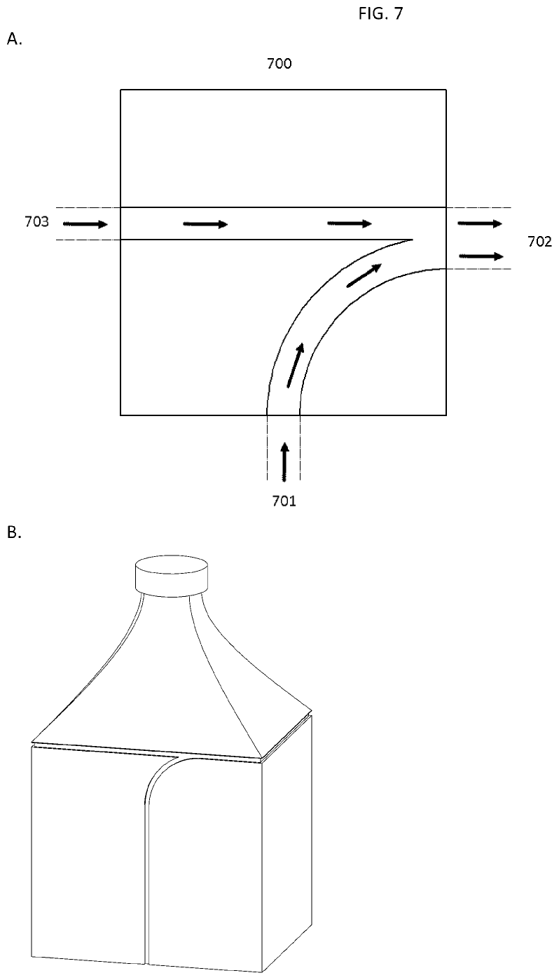

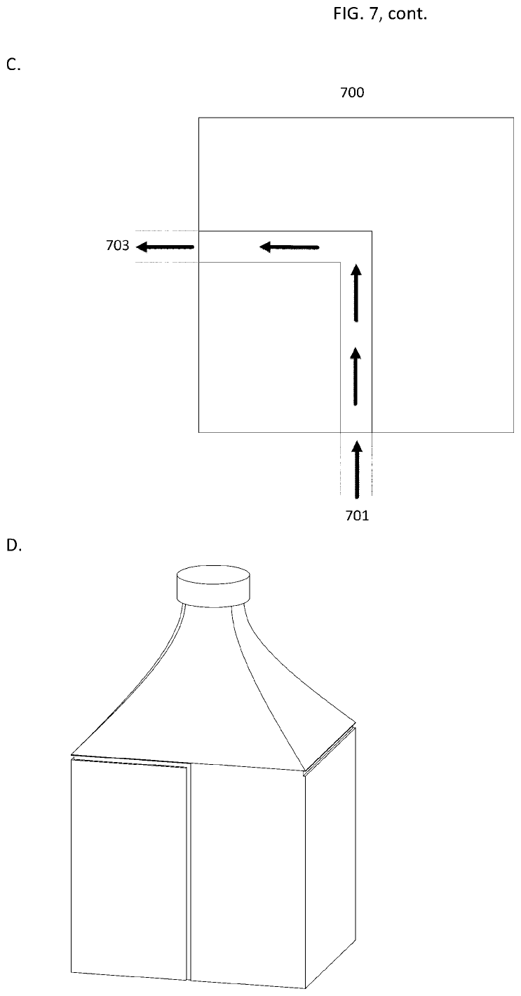

FIG. 7, panel A depicts a top view of a direction-changing component that can be utilized in the subject thermoplastic containers. In the depicted embodiment, the direction-changing component 700 comprises a first entry point 701, an exit point 702, and a second entry point 703. In use, a separating component enters the direction changing component 700 on a first pass at the first entry point 701, and changes direction by 90 degrees as it traverses to the exit point 702. On a second pass, the separating component enters the direction-changing component at the second entry point 703, then exits the direction-changing component at the exit point 702. Panel B depicts a container in accordance with one embodiment of the invention, showing the location of the direction-changing component depicted in panel A in the larger context of the entire container. In this depicted embodiment, separating the container along the depicted rupture seam or trough completely separates the lid from the remainder of the container, thereby creating two different component parts. In some embodiments, these two different parts can be recycled separately, such as, for example, when the lid comprises a cap that is made from a material that needs to be recycled in a manner that is different the rest of the container.

FIG. 7, panel C depicts a top view of another direction-changing component that can be utilized in the subject thermoplastic containers. In this depicted embodiment, the direction-changing component 700 comprises a first entry point 701, and an exit point 703. In use, a separating component enters the direction changing component 700 at the first entry point 701, and changes direction by 90 degrees as it traverses to the exit point 703. Panel D depicts a container in accordance with one embodiment of the invention, showing the location of the direction-changing component depicted in panel C in the larger context of the entire container. In this depicted embodiment, separating the container along the depicted rupture seam or trough separates the lid from the remainder of the container along all sides except along the upper right portion of the wall segment that is closest to the viewer, thereby creating a hinged connection between the lid and the wall segment.

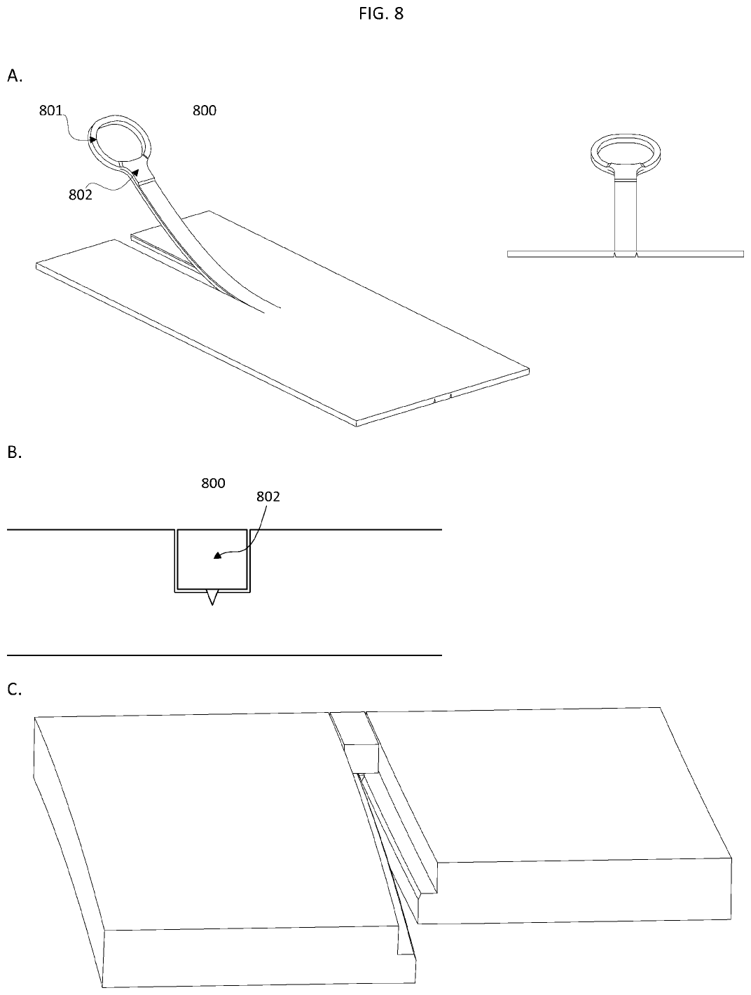

FIG. 8 depicts a variety of separating components that can be utilized in the subject thermoplastic containers. Panel A shows an assembly 800 comprising a separating component 802 disposed in a trough. In Panel A, the depicted separating component 802 comprises a ring 801. The separating component 802 depicted in Panel A has initiated a tear in the thermoplastic material, and is propagating the tear along a trough or rupture seam to separate two or more portions of the thermoplastic container. In Panel B, a cross-sectional view of the assembly 800 is shown, with the separating component 802 positioned within a trough. Panel C is a perspective view, showing two portions of the container separating from one another after the separating component has traversed the trough or rupture seam.

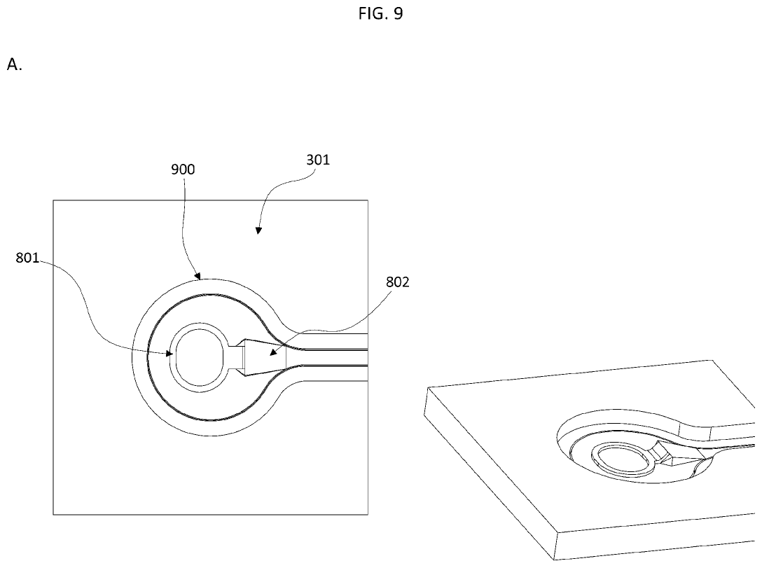

FIG. 9 depicts a recess, or depression, with a separating component positioned therein, as well as a perspective view. In the depicted embodiment, a recess 900 is disposed in a base 301, and a separating component 802 comprising a ring 801 is positioned with the depression 900.

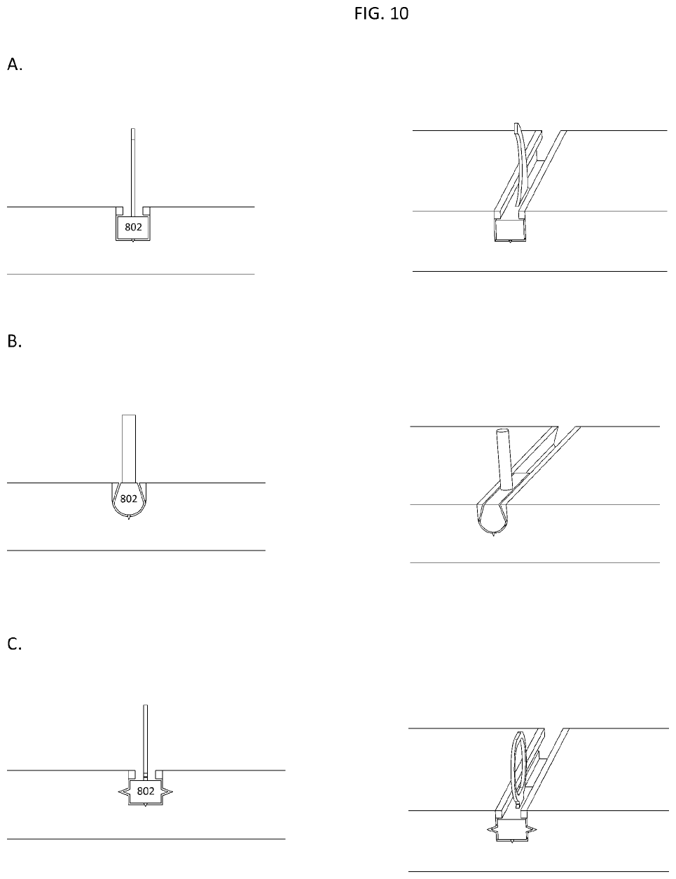

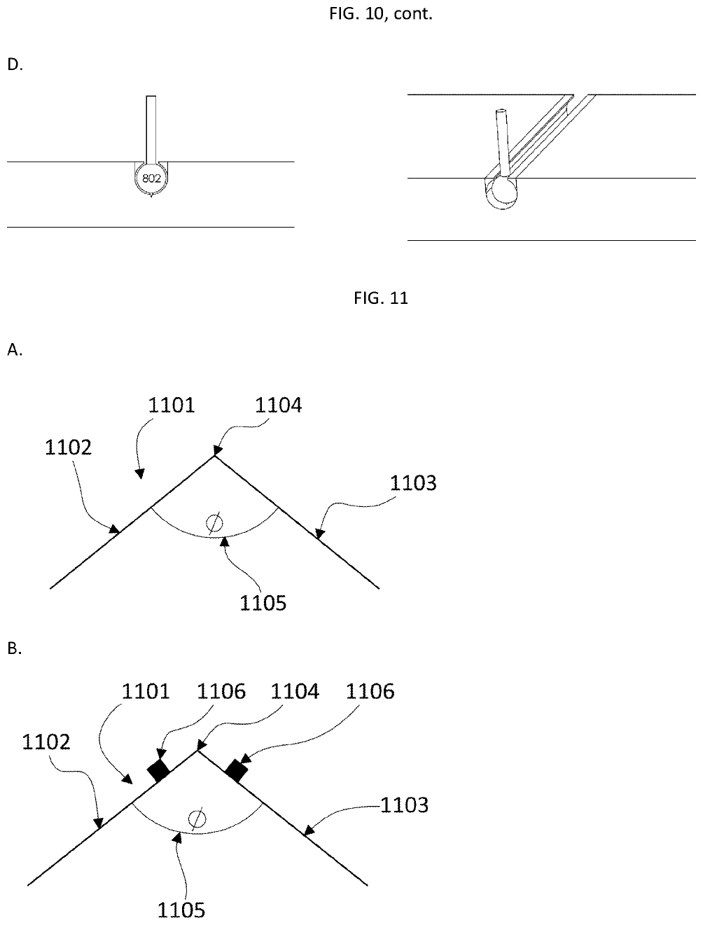

FIG. 10 depicts a variety of separating components paired with retention and/or guide components that can be utilized in the subject thermoplastic containers. In Panel A, a square-shaped separating component 802 is positioned within a square-shaped trough, and the trough comprises two extending ledges that serve as retention and/or guide components, as well as a perspective view. In Panel B, a U-shaped separating component 802 is positioned within a U-shaped trough, and the trough comprises two thickened trough edges that serve as retention and/or guide components, as well as a perspective view. In Panel C, a square-shaped separating component is positioned within a square-shaped trough, and the trough comprises two V-shaped grooves that serve as retention and/or guide components, and the separating component comprises two complimentary projections that conform to the grooves. A perspective view is also provided, showing that the separating component comprises a ring pull. In panel D, a spherical separating component is positioned within a U-shaped trough. The spherical separating component can travel in a non-linear direction along the trough, since its geometry does not constrain it to rectilinear movements. In certain embodiments, a trough has a non-linear trajectory, for example, containing one or more arcs, curves, corners, and/or other non-linear features, and the spherically-shaped separating component can traverse the trajectory of the trough along such features in a continuous manner.

In all of the embodiments depicted in FIG. 10, the separating component 802 comprises a geometry that conforms to the shape of the trough, which facilitates guiding the separating component along the length of the trough, as well as retaining the separating component within the trough.

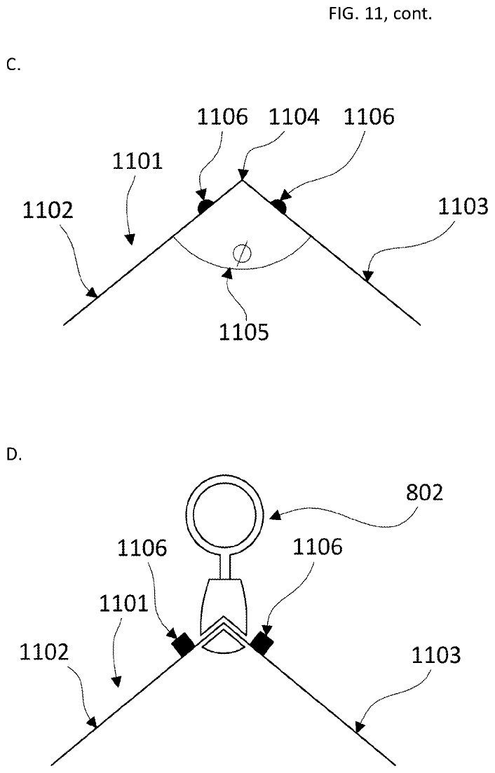

FIG. 11, panel A, depicts an angular wall component 1101 comprising a first substantially planar element 1102, a second substantially planar element 1103, a ridge 1104 formed at the junction of the first and second substantially planar elements (1102, 1103), and an angle, θ (1105) formed at the junction. FIG. 11, panel B, depicts the same elements as in panel A, but further depicts two guide components 1106 that project from the surface of the substantially planar elements (1102, 1103). The guide components 1106 depicted in FIG. 11, panel B, comprise a square cross-sectional geometry. FIG. 11, panel C depicts the same elements as in panel B, except the guide components 1106 depicted in panel C comprise a rounded, or semi-circular geometry.

FIG. 11, panel D, depicts an angular wall component 1101 comprising a first substantially planar element 1102, a second substantially planar element 1103, a ridge 1104 formed at the junction of the first and second substantially planar elements (1102, 1103), and an angle, θ (1105) formed at the junction. FIG. 11, panel D, also depicts an integrated separating component 802 engaged with the angular wall component 1101. The depicted integrated separating component 802 comprises a geometry that conforms to the features of the angular wall component 1101. FIG. 11, panel D, also depicts two guide components 1104 comprising a square cross-sectional geometry. The guide components function to keep the integrated separating component 802 aligned with the ridge 1103 of the angular wall component 1101.

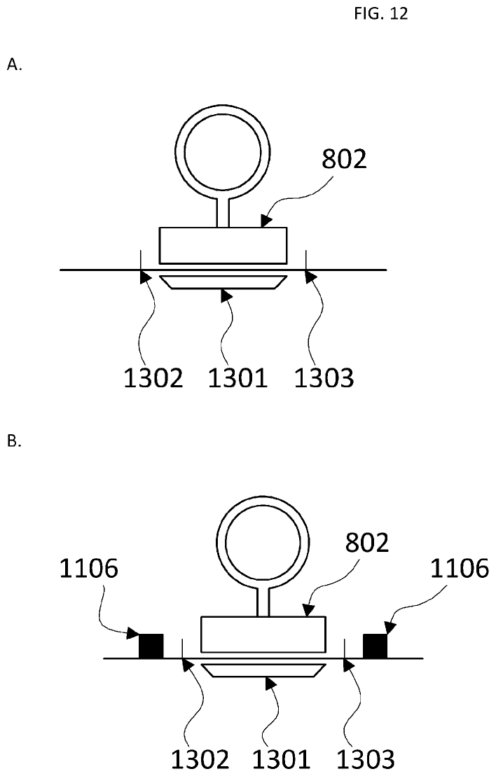

FIG. 12, panel A, depicts a rupture seam 1301 comprising a first side 1302 and second side 1303, as well as a separating component 802 positioned therein. In panel B, the rupture seam 1301 further comprises guide components 1106 positioned on either side of the rupture seam, and have a square cross-sectional geometry.

FIG. 13, panel A, depicts a three-sided thermoplastic container in accordance with one embodiment of the invention. The depicted thermoplastic container comprises a set of upper wall segments, each of which has a trapezoidal shape, and three lower wall segments, each of which has a rectangular shape. The depicted container also comprises a base having a triangular shape. The upper wall segments come together to form a triangular opening at the top of the container. Panel B depicts a three-sided thermoplastic container in accordance with one embodiment of the invention. The depicted thermoplastic container comprises a set of upper wall segments, each of which has a trapezoidal shape, and three lower wall segments, each of which has a rectangular shape. The depicted container also comprises a base having a triangular shape. The upper wall segments come together to form a circular opening at the top of the container.

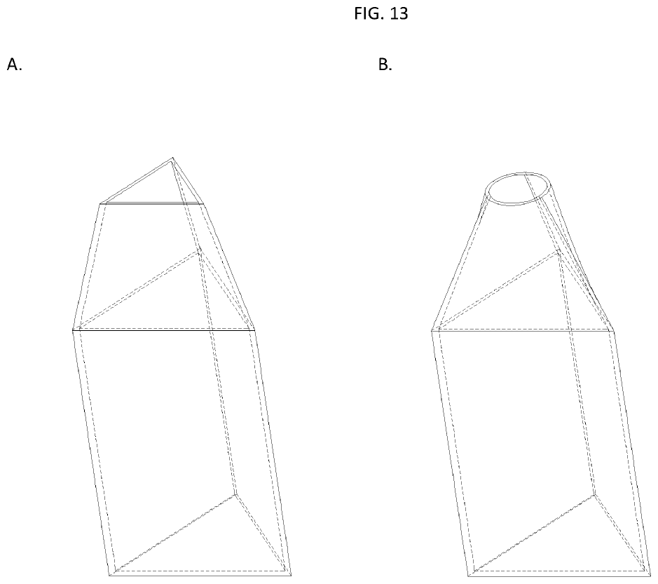

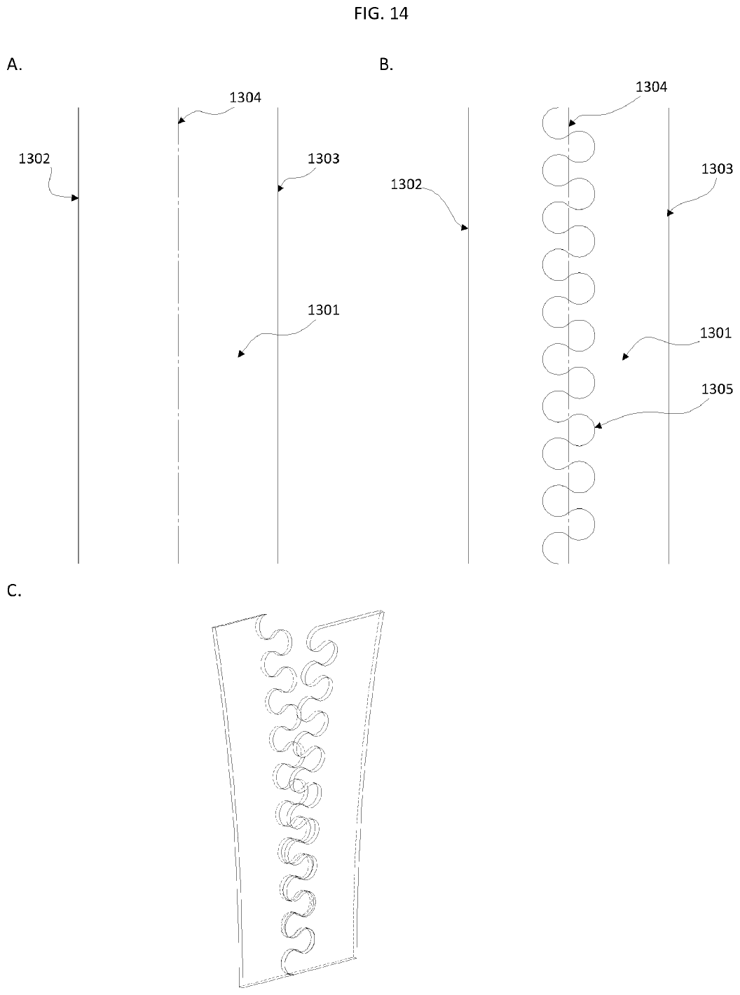

FIG. 14, panel A, depicts a rupture seam 1301 comprising a first side 1302, a second side 1303 and a longitudinal axis 1304 running down the center of the rupture seam. The rupture seam 1301 depicted in FIG. 13, panel A, comprises a symmetric geometry, wherein both sides (1302, 1303) of the rupture seam are identical on either side of the longitudinal axis 1304. FIG. 13, panel B, depicts a rupture seam 1301 comprising a first side 1302, a second side 1303 and a longitudinal axis 1304 running down the center of the rupture seam. The rupture seam 1301 depicted in FIG. 13, panel B, comprises an asymmetric geometry, wherein the first side 1302 and the second side 1303 are not identical on either side of the longitudinal axis 1304. The asymmetric rupture seam depicted in panel B comprises a plurality of teeth 1305, similar to those of a zipper. Upon separation of the rupture seam 1301, the first and second sides of the rupture seam (1302, 1303) comprise a blunt edge that can minimize injuries to a user. Panel C is three-dimensional representation of the rupture seam depicted in panel B, wherein the upper portion of the rupture seam has been separated to create to two different pieces.

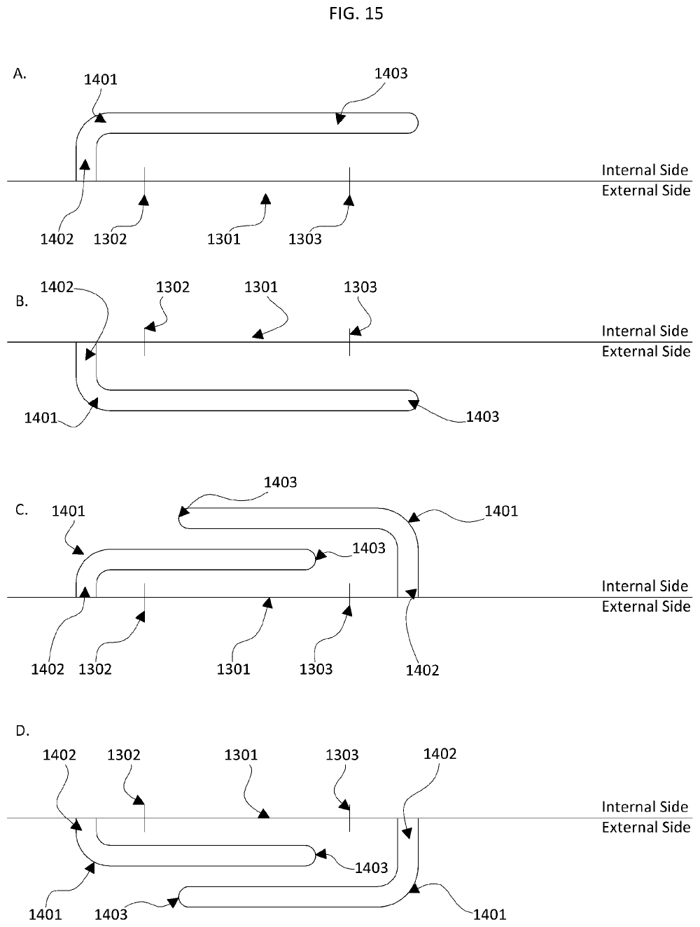

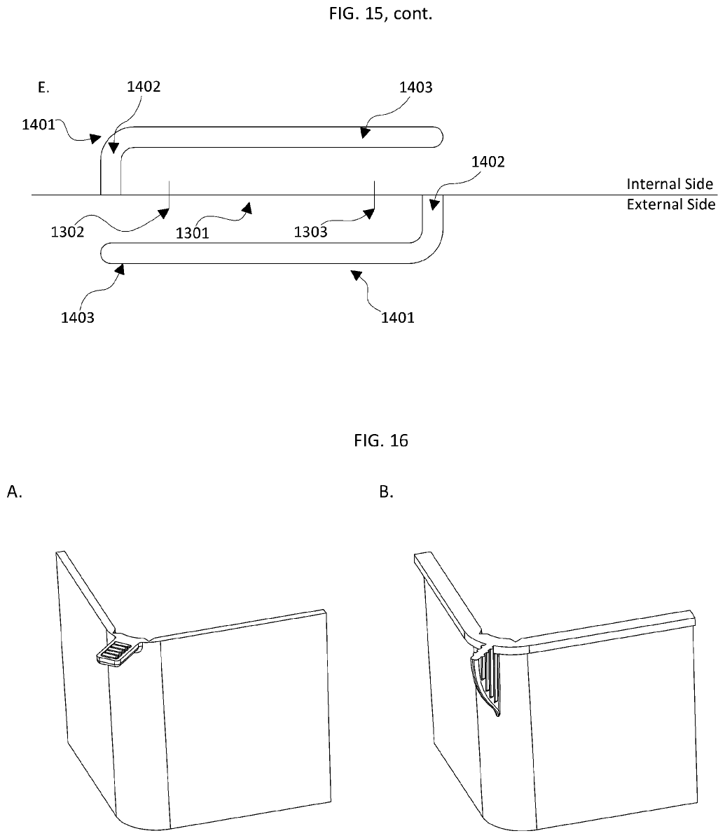

FIG. 15, panel A, depicts a rupture seam 1301 comprising a first side 1302 and a second side 1303. Also depicted is a rupture seam underlay 1401 comprising a base 1402 and an extension component 1403. In the embodiment depicted in FIG. 15, panel A, the extension component 1403 is long enough to extend across the entire rupture seam 1301. In the embodiment depicted in FIG. 15, panel A, the rupture seam underlay 1401 is disposed on an internal surface of the thermoplastic container.

FIG. 15, panel B, depicts a rupture seam 1301 comprising a first side 1302 and a second side 1303. Also depicted is a rupture seam underlay 1401 comprising a base 1402 and an extension component 1403. In the embodiment depicted in FIG. 15, panel B, the extension component 1403 is long enough to extend across the entire rupture seam 1301. In the embodiment depicted in FIG. 15, panel B, the rupture seam underlay 1401 is disposed on an external surface of the thermoplastic container.

FIG. 15, panel C, depicts a rupture seam 1301 comprising a first side 1302 and a second side 1303. Also depicted are two rupture seam underlays 1401, each comprising a base 1402 and an extension component 1403. In the embodiment depicted in FIG. 15, panel C, the extension component 1403 of each rupture seam underlay is not long enough to extend across the entire rupture seam 1301. The rupture seam underlays 1401 overlap with one another near the center of the rupture seam 1301. In the embodiment depicted in FIG. 15, panel C, the rupture seam underlays 1401 are both disposed on an internal surface of the thermoplastic container.

FIG. 15, panel D, depicts a rupture seam 1301 comprising a first side 1302 and a second side 1303. Also depicted are two rupture seam underlays 1401, each comprising a base 1402 and an extension component 1403. In the embodiment depicted in FIG. 15, panel D, the extension component 1403 of each rupture seam underlay is not long enough to extend across the entire rupture seam 1301. The rupture seam underlays 1401 overlap with one another near the center of the rupture seam 1301. In the embodiment depicted in FIG. 15, panel D, the rupture seam underlays 1401 are both disposed on an external surface of the thermoplastic container.

FIG. 15, panel E, depicts a rupture seam 1301 comprising a first side 1302 and a second side 1303. Also depicted are two rupture seam underlays 1401, each comprising a base 1402 and an extension component 1403. In the embodiment depicted in FIG. 15, panel E, the extension component 1403 of each rupture seam underlay is long enough to extend across the entire rupture seam 1301. In the embodiment depicted in FIG. 15, panel E, one rupture seam underlay 1401 is disposed on an internal surface of the thermoplastic container, and one rupture seam underlay 1401 is disposed on an external surface of the thermoplastic container.

FIG. 16 depicts various separating components in accordance with embodiments of the invention. In panel A, the separating component comprises a horizontally-oriented pull tab with a rectangular shape. The rectangular pull tab also comprises a plurality of ridges that provide additional graspability. In panel B, the separating component comprises a vertically-oriented pull tab with a roughly triangular, or “wing” shape. The pull tab also comprises a plurality of ridges that provide additional graspability. In panel C, the separating component also comprises a vertically-oriented pull tab with a roughly triangular, or “wing” shape. This pull tab comprises a non-planar geometry that provides additional graspability. In panel D, the separating component comprises a horizontally-oriented pull tab with a rectangular shape, but which is hingedly connected to the container in a manner that allows the pull tab to be folded against the vertical wall of the container when not in use, so as to minimize snagging. In panel E, the separating component comprises a ring pull tab, but which is also hingedly connected to the container in a manner that allows the ring pull tab to be folded against the vertical wall of the container when not in use, so as to minimize snagging.

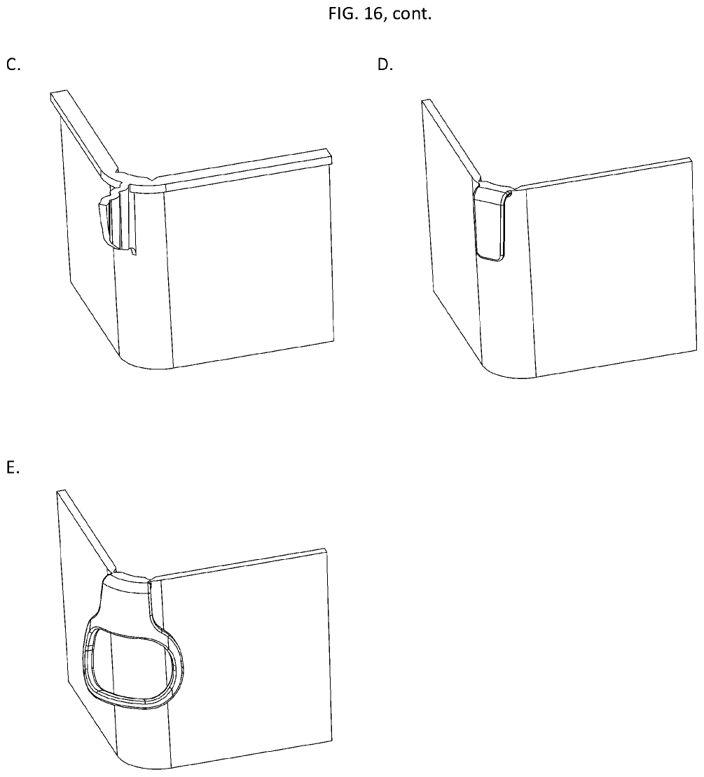

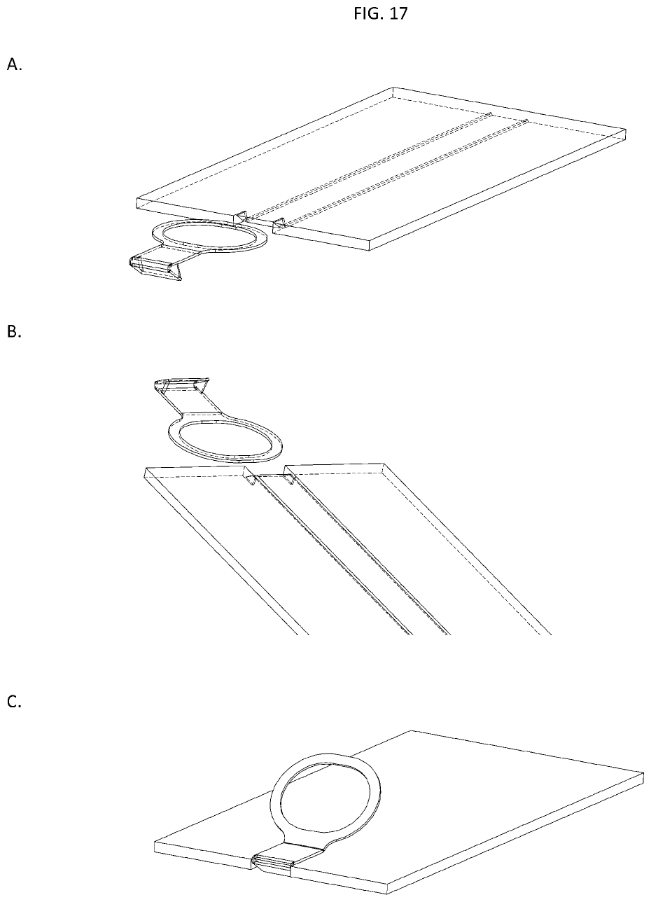

FIG. 17, panels A-C, depict an integrated separating component comprising a ring pull tab and a cutting element comprising two cutting edges, or blades. In use, the cutting element is engaged with the material of the container at a first end of a rupture seam. As the cutting element engages with the material, the two cutting edges initiate two parallel tears in the material. The user continues to pull on the ring pull tab, thereby propagating the two parallel tears through the material along the rupture seam to separate the container. Panels A and B are different perspective views of the integrated separating component and the rupture seam in which it travels when engaged with the container. Panel C depicts the separating component engaged with the container before the two parallel tears have been propagated to separate the container.

FIG. 18 is an illustration of a multi-sided container in accordance with one embodiment of the invention. Panel A shows the depicted embodiment in a three-dimensional configuration, having a plurality of arc-shaped wall segments that come together to form a circular shape. The arc-shaped wall segments are connected by narrow rectangular wall segments, which in some embodiments are made from the same material as the arc-shaped wall segments, and in other embodiments, are made from a material that is different from the material of the arc-shaped wall segments. Panel B depicts the container depicted in panel A, after a rupture seam or trough between two adjacent wall segments has been separated, and a rupture seam or trough that extends along all but one of the edges of the base has been separated, thereby transitioning the container to a substantially flat configuration. In certain embodiments, the base of the depicted container can be completely separated from the wall segments.

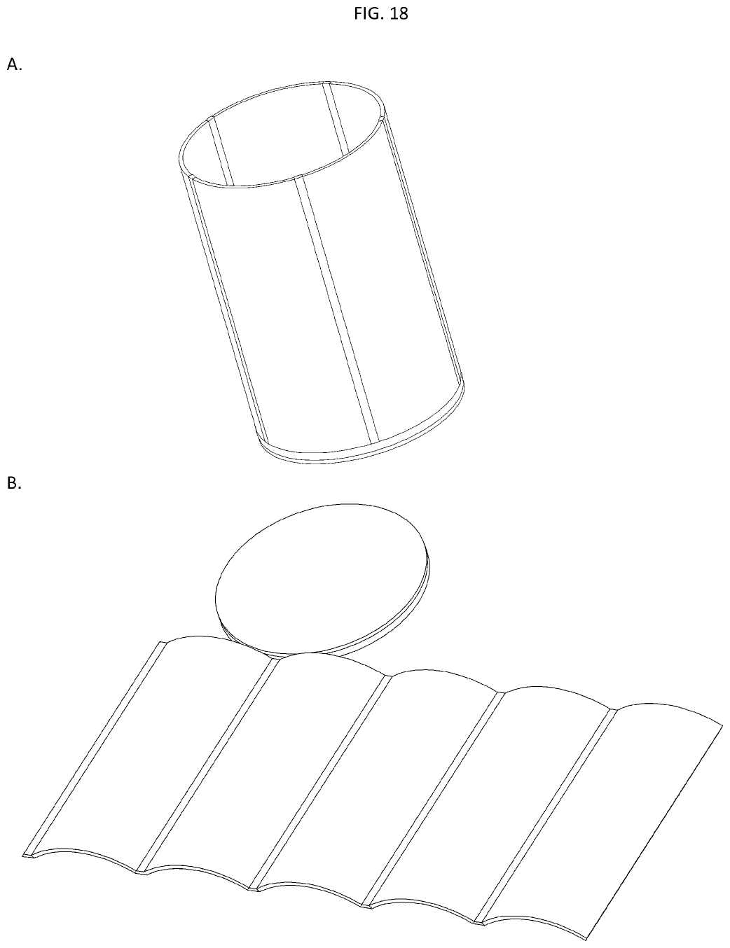

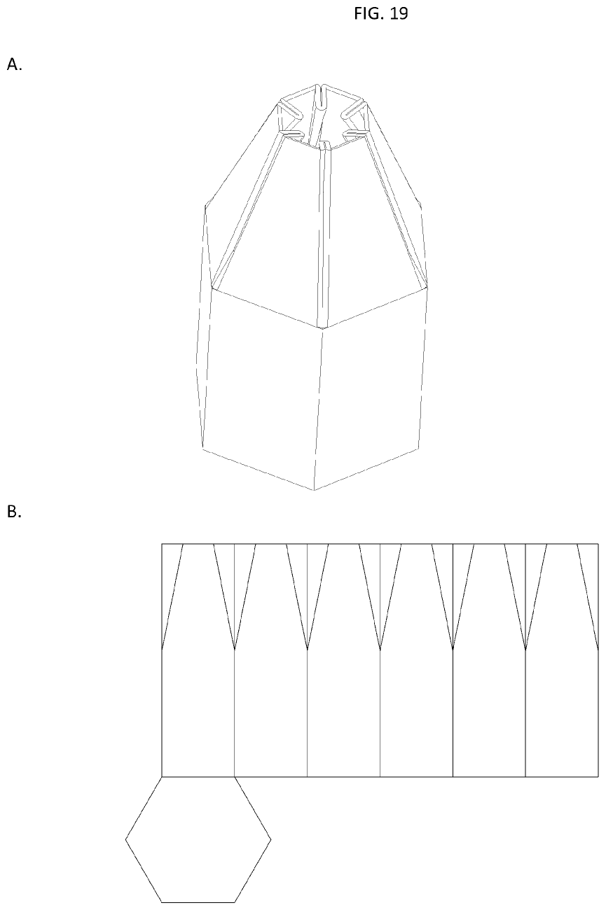

FIG. 19 is an illustration of a multi-sided container in accordance with one embodiment of the invention. Panel A shows the depicted embodiment in a three-dimensional configuration, having six sides. The depicted container comprises upper wall segments that have a rectangular shape, but that are pleated to form an upper region of the container with a reduced diameter.

Panel B depicts the container depicted in panel A, after a rupture seam or trough between two adjacent wall segments has been separated, and a rupture seam or trough that extends along all but one of the edges of the base has been separated, thereby transitioning the container to a substantially flat configuration. In this depicted embodiment, when the container is transitioned to a substantially flat configuration, the pleating between the upper wall segments is unfolded, resulting in the wall segments adopting a rectangular shape. In certain embodiments, the base of the depicted container can be completely separated from the wall segments, resulting in a rectangular sheet of material that was used to make up the wall segments of the container, and a flat hexagonal piece of material that was used to make the base of the container.

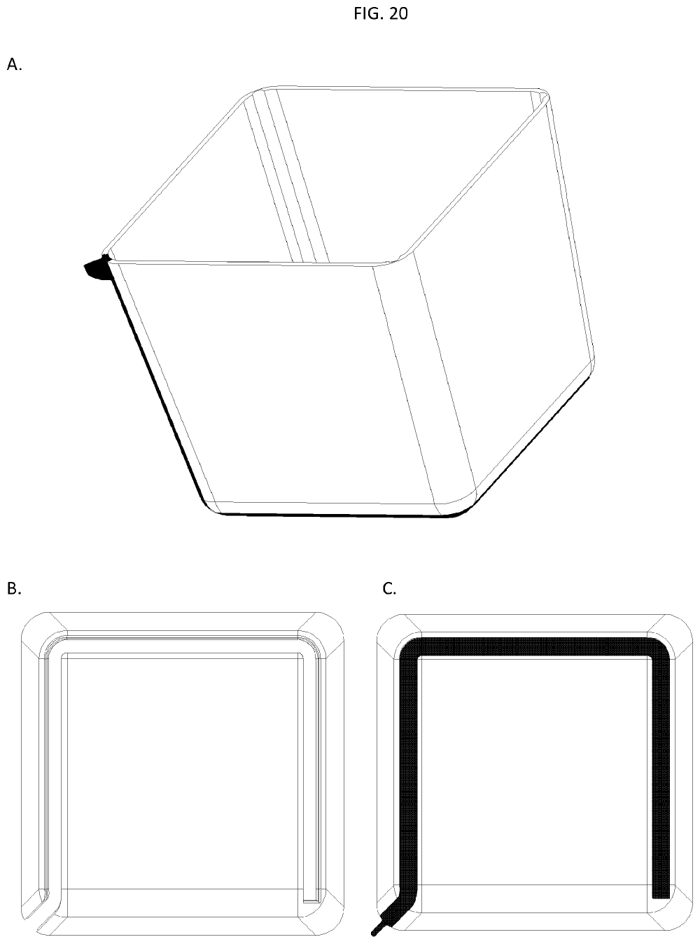

FIG. 20, panel A, depicts a container produced using a two-shot injection molding process. In the depicted embodiment, the bulk of the container (i.e., all portions of the container except for the separating components and the rupture seams) is injection molded from a first thermoplastic material. The molded part associated with this first step is depicted in panel B. The molded and solidified thermoplastic container is then transferred to a second mold cavity, using a rotating platen or another suitable multi-shot process part transfer apparatus, where a second shot of the same or different thermoplastic material is injected to form the separating component and rupture seam sections of the container. The fully molded container associated with this second shot is depicted in panel C.

### Utility

The subject thermoplastic containers, systems and methods are useful in a variety of ways, including, but not limited to, providing enhanced recyclability. For example, by adopting a substantially flat configuration, the subject thermoplastic containers have a reduced, or eliminated, internal void volume. By converting to a substantially flat configuration, the subject thermoplastic containers take up less space in recycling centers, and can also be transported more efficiently. Furthermore, by adopting a substantially flat configuration, the subject thermoplastic containers help to eliminate standing water, which can present public health risks. For example, standing water is known to facilitate breeding of insects, such as mosquitos, which can transmit diseases, such as malaria. Furthermore, the enhanced recyclability of the subject thermoplastic containers further reduces the environmental impact of disposable containers by reducing wildlife consumption of inedible waste.

The subject thermoplastic containers, systems and methods also provide enhanced recyclability by facilitating easier cleaning of the interior surface of the containers. By adopting an alternate configuration, such as a substantially flat configuration, more internal surfaces of the subject containers become easily accessible, and can be effectively cleaned prior to recycling. This is in contrast to existing thermoplastic containers, where the inner surface can only be accessed via the opening of the container, which constrains cleaning processes.

Additionally, the subject thermoplastic containers, systems and methods facilitate a reduction in the carbon dioxide emissions attributable to recycling activities. Through improvements in transportation efficiency, more cost-effective waste management procedures, and more efficient after-market use of recyclable materials, the carbon footprint associated with production, use and recycling of the subject thermoplastic containers is reduced as compared to the carbon footprint associated with the same activities as applied to existing thermoplastic containers.

The invention now being fully described, it will be apparent to one of ordinary skill in the art that various changes and modifications can be made without departing from the spirit or scope of the invention.

### Examples

### Example 1: Thermoplastic Container

A thermoplastic container having a three-dimensional configuration is formed from a square base with four sides, four wall segments, each having a rectangular shape, and a square lid comprising a proximal end and a distal end, wherein the proximal end comprises four edges, and the distal end comprises a cap. The base comprises three base troughs, each disposed between one edge of a base and an adjoining wall segment. One of the wall segments comprises a wall trough positioned within the wall segment. The lid comprises four lid troughs, each disposed between one edge of the lid and an adjoining wall segment. A first direction-changing component is disposed at a junction of a base trough and the wall trough. A second direction-changing component is disposed at a junction of the wall trough and a lid trough. Disposed within the base is a recessed depression that houses a separating component.

### Example 2: Method of Converting a Thermoplastic Container

The thermoplastic container of Example 1 is converted from a three-dimensional configuration into a substantially flat configuration. The separating component disposed in the recessed depression in the base is removed from the depression, thereby initiating a tear in the material of the thermoplastic container within one of the base troughs. The separating component is then passed along the three base troughs to separate the base from the remainder of the container in a hinged manner, wherein the base remains connected to the remainder of the container along one edge, where it is connected to an adjoining wall segment. The separating component is passed through the first direction-changing component to transition the separating component from a base trough to the wall trough. The separating component is passed along the wall trough and into the second direction-changing component to transition the separating component from the wall trough into one of the lid troughs. The separating component is passed along all four of the lid troughs to separate the lid from the thermoplastic container. The separated lid portion, which comprises the cap, is recycled in a suitable manner. The remainder of the container, which comprises the base and the wall segments in a substantially flat configuration, is recycled in a suitable manner.

### Example 3: System and Method for Converting Thermoplastic Containers

A thermoplastic container having a three-dimensional configuration is converted into a substantially flat configuration using a separating component that is disposed in a stand-alone apparatus. The thermoplastic container comprises a square base with four sides, four wall segments, each having a rectangular shape, and a square lid comprising a proximal end and a distal end, wherein the proximal end comprises four edges, and the distal end comprises a cap. The base comprises three base troughs, each disposed between one edge of a base and an adjoining wall segment. One of the wall segments comprises a wall trough positioned within the wall segment. The lid comprises four lid troughs, each disposed between one edge of the lid and an adjoining wall segment. A first direction-changing component is disposed at a junction of a base trough and the wall trough. A second direction-changing component is disposed at a junction of the wall trough and a lid trough.

An operator obtains an empty thermoplastic container as described above, and places the thermoplastic container in a receptacle of an apparatus comprising a separating component. The operator then initiates a separation procedure, which proceeds by initiating a tear in the material of the thermoplastic container within one of the base troughs. The separating component is then passed along the three base troughs to separate the base from the remainder of the container in a hinged manner, wherein the base remains connected to the remainder of the container along one edge, where it is connected to an adjoining wall segment. The separating component is then passed through the first direction-changing component to transition the separating component from a base trough to the wall trough. The separating component is then passed along the wall trough and into the second direction-changing component to transition the separating component from the wall trough into one of the lid troughs. The separating component is then passed along all four of the lid troughs to separate the lid from the thermoplastic container. The separated lid portion, which comprises the cap, is recycled in a suitable manner. The remainder of the container, which comprises the base and the wall segments, is recycled in a suitable manner.

### Example 4: Injection Molded Container

In one embodiment, an injection molded container comprises one or more tear strips as part of the integrated separating components. Separating components, such as those depicted in FIG. 16, comprise integral material strips that are bounded on each side by wall troughs having a reduced thickness, and therefore, reduced strength. Each tear strip can incorporate a pull tab to facilitate initiation of a tear. In some embodiments, the tear strips are oriented in such a way as to eliminate undercuts that would prevent distortion or damage to the container during the part ejection step of the injection molding process, thereby eliminating the need for complicated moving mold sections. In some embodiments, hinge features, such as those shown in FIG. 5, panel C, can be added at intact corners (i.e., those corners that are designed not to separate) to facilitate transitioning the container into a substantially flat configuration after tearing of the separating components. In some embodiments, the tear strips can be designed to fully separate from the collapsed container, or remain as an integral component of the collapsed container for greater recycling efficiency.

### Example 5: Two-Shot Injection Molded Container

In one embodiment, an injection molded container is produced using a multi-shot injection molding process (i.e., a two shot injection molding process) as depicted in FIG. 20. In some embodiments, the container is produced in a two-step injection molding process. In the first step, the bulk of the container (i.e., all portions of the container except for the separating components and the rupture seams) are injection molded from a first thermoplastic material. The molded part associated with this first step is depicted in FIG. 20, panel B. The molded and solidified thermoplastic container is then transferred to a second mold cavity, using a rotating platen or another suitable multi-shot process part transfer apparatus, where a second shot of the same or different thermoplastic material is injected to form the separating component and rupture seam sections of the container. The fully molded container associated with this second shot is depicted in FIG. 20, panel C. Depending on the mold design, each separating component can (i) have its own material injection point or (ii) use a single injection point and an integral runner to direct material to the separating components. In some embodiments, the separating component and the forces that it exerts on the components of the container are controlled by the degree of welding and/or adhesion between the two materials, as well as the joint design features employed, such as surface area of contact. FIG. 20 depicts a half lap joint design, but other joint designs, including but not limited to butt joints, tongue and groove joints, scarf joints and V-groove joints are also possible. In some embodiments, the separating components can comprise a pull tab in order to facilitate initiation of the separating process. Selection of the thermoplastic material combination, process conditions and joint design can be optimized based on the forces that need to be generated to successfully separate the container. In some embodiments, the second thermoplastic material used to produce the separating components is the same as the material used to create the bulk of the container, in order to facilitate recycling of the collapsed container. In some embodiments, the second material is compatible with the material of the container so as to allow comingled recycling of the collapsed container. In some embodiments, the material used to make the separating component does not have the same recyclability properties as the material that makes up the bulk of the container, and as such, the separating component is configured to be separated from the remainder of the container, and separately recycled.

### Example 6: Blow Molded Container

In one embodiment, a container comprises separating components that are produced using a thermoplastic blow molding process, such as a co-extrusion or co-injection blow molding process. Co-extrusion blow molding processes are used to produce thermoplastic containers having one or more stripes of material having different color or light transmission characteristics. Examples of such containers and processes are described, for example, in U.S. Pat. No. 3,343,568, the disclosure of which is incorporated by reference herein in its entirety. The co-extruded stripe(s) extend longitudinally over the length of the extruded tube or parison that is then blown with compressed gas to form the container as shown in FIG. 4, panel H. The integral extruded stripes extend through the thickness of the container and typically serve as a sight or level indicator for the container contents. The thermoplastic material used for the stripe(s) is generally similar to that of the container itself, except that in some embodiments the material is visually different. In certain embodiments, the material used for the stripe(s) is structurally equivalent, while in other embodiments, the material used for the stripe(s) is structurally different (e.g., has different mechanical properties).

In one embodiment, the stripes are positioned and formulated to function as an integrated separating component, designed to facilitate transition of the container from a first configuration to a second configuration (e.g., a stackable configuration, or a substantially flat configuration) for enhanced recyclability. In some embodiments, the container and stripe materials are selected to provide sufficient structure for the container application, however, the adhesion between the stripe(s) and the adjacent container wall sections allows for separation when the container is broken down. In some embodiments, the container wall sections adjacent to the stripe(s) can also include pull tab-like features that facilitate separation of the container into one or more component parts of predetermined configuration. Embodiments comprising one or more of the features described above can also be produced using, e.g., a co-extrusion blow molding process, an accumulator blow molding process, and/or an injection blow molding process (using co-injection molded stripe preforms).

Notwithstanding the appended claims, the disclosure is also defined by the following clauses:

1. A thermoplastic container comprising: a base comprising a plurality of edges along its perimeter; a plurality of wall segments extending orthogonally from each edge of the base; and an integrated separating component configured to separate the thermoplastic container, thereby allowing the thermoplastic container to adopt a substantially flat configuration.
2. The thermoplastic container of clause 1, further comprising: at least one wall trough; and at least one base trough disposed between a first edge of the base and a wall segment; wherein the integrated separating component is configured to separate the thermoplastic container along the at least one wall trough and the at least one base trough.
3. The thermoplastic container according to clause 1 or 2, further comprising a lid comprising a plurality of edges.
4. The thermoplastic container of clause 3, wherein the lid is connected to at least one wall segment along at least a portion of at least one edge of the lid.
5. The thermoplastic container of clause 4, wherein the lid is connected to at least one wall segment along an entire edge of the lid.
6. The thermoplastic container of clause 3, wherein the lid is a flush-type lid or a plug-type lid.
7. The thermoplastic container of clause 3, wherein the lid comprises a distal end and a proximal end; wherein the proximal end comprises a plurality of edges along its perimeter, and at least one lid trough disposed between a first edge of the lid and a wall segment; and wherein the integrated separating component is further configured to separate the thermoplastic container along the at least one lid trough.
8. The thermoplastic container of clause 7, wherein the lid trough extends along an entire perimeter of the proximal end of the lid, and wherein the integrated separating component is configured to separate the thermoplastic container along the entire perimeter of the lid, thereby separating the lid from the thermoplastic container.
9. The thermoplastic container according to any one of clauses 7 or 8, wherein the distal end of the lid comprises a cap.
10. The thermoplastic container of clause 9, wherein the cap comprises a cap liner and/or a cap seal.
11. The thermoplastic container according to any one of the preceding clauses, wherein the at least one wall trough is disposed between two adjacent wall segments.
12. The thermoplastic container according to any one of clauses 1-11, wherein the at least one wall trough is disposed within a wall segment.
13. The thermoplastic container according to any one of the preceding clauses, wherein the base trough, the wall trough, and/or the lid trough comprises a U-shaped cross sectional geometry.
14. The thermoplastic container according to any one of clauses 1-12, wherein the base trough, the wall trough, and/or the lid trough comprises a V-shaped cross sectional geometry.
15. The thermoplastic container according to any one of clauses 1-12, wherein the base trough, the wall trough, and/or the lid trough comprises a rectangular cross sectional geometry.
16. The thermoplastic container according to any one of the preceding clauses, wherein the base trough, the wall trough, and/or the lid trough comprises a guide component configured to guide the integrated separating component along a length of a trough.
17. The thermoplastic container of clause 16, wherein the guide component comprises a thickened trough edge.
18. The thermoplastic container of clause 16, wherein the guide component comprises a ledge that projects over an edge of a trough.
19. The thermoplastic container according to any one of clauses 16-18, wherein the guide component comprises a groove, or a combination of grooves, which are disposed within the trough.
20. The thermoplastic container according to any one of the preceding clauses, wherein the base trough, the wall trough, and/or the lid trough comprises a retention component configured to retain the integrated separating component within a trough.
21. The thermoplastic container of clause 20, wherein the retention component comprises a thickened trough edge.
22. The thermoplastic container of clause 20, wherein the retention component comprises a ledge that projects over an edge of a trough.
23. The thermoplastic container according to any one of clauses 20-22, wherein the guide component comprises a groove, or a combination of grooves, which are disposed within the trough.
24. The thermoplastic container according to any one of the preceding clauses, wherein the base trough, the wall trough, and/or the lid trough comprises a thermoplastic material that is different from a thermoplastic material of the base, the wall segments, and/or the lid.
25. The thermoplastic container according to any one of clauses 1-23, wherein the base trough, the wall trough, and/or the lid trough comprises a thermoplastic material that is the same as a thermoplastic material of the base, the wall segments, and/or the lid.
26. The thermoplastic container according to any one of the preceding clauses, wherein the base trough, the wall trough, and/or the lid trough comprises a thermoplastic material that has one or more different mechanical properties from a thermoplastic material of the base, the wall segments, and/or the lid.
27. The thermoplastic container according to any one of the preceding clauses, wherein the base trough, the wall trough, and/or the lid trough comprises one or more direction-changing components that are configured to direct the integrated separating component to transition from a first trough to a second trough at a junction location.
28. The thermoplastic container of clause 27, wherein the direction-changing component is disposed at an intersection of a base trough and a wall trough.
29. The thermoplastic container of clause 27, wherein the direction-changing component is disposed at an intersection of a wall trough and a lid trough.
30. The thermoplastic container of clause 27, comprising a first direction-changing component disposed at an intersection of a base trough and a wall trough, and a second direction-changing component located at an intersection of a wall trough and a lid trough.
31. The thermoplastic container according to any one of the preceding clauses, wherein the integrated separating component comprises a blade.
32. The thermoplastic container of clause 31, wherein the blade is a fixed blade.
33. The thermoplastic container of clause 31, wherein the blade is a retractable blade.
34. The thermoplastic container of clause 31, wherein the integrated separating component comprises a blade guard.
35. The thermoplastic container of clause 31, further comprising a blade-engaging component.
36. The thermoplastic container according to any one of clauses 31-35, wherein the blade is disposed within a recessed area of the integrated separating component.
37. The thermoplastic container of clause 36, wherein the recessed area of the integrated separating component is configured to engage with one or more portions of the thermoplastic container.
38. The thermoplastic container according to any one of clauses 1-30, wherein the integrated separating component comprises a tear-initiating component.
39. The thermoplastic container of clause 38, wherein the tear-initiating component is configured to initiate a tear in the thermoplastic container, and the integrated separating component is configured to propagate the tear along a base trough, a wall trough, and/or a lid trough.
40. The thermoplastic container according to any one of clauses 1-39, wherein the integrated separating component comprises a pull tab.
41. The thermoplastic container according to any one of clauses 1-40, wherein the integrated separating component is disposed within a depression.
42. The thermoplastic container of clause 41, wherein the depression is disposed in the base, the lid, one or more wall segments, or any combination thereof.
43. The thermoplastic container of clause 41, wherein the integrated separating component is configured to initiate a separation of the thermoplastic container upon removal of the integrated separating component from the depression.
44. The thermoplastic container according to any one of the preceding clauses, wherein the integrated separating component comprises a guide component configured to guide the integrated separating component along a trough.
45. The thermoplastic container according to any one of the preceding clauses, wherein the integrated separating component comprises a retention component configured to retain the integrated separating component within a trough.
46. The thermoplastic container according to any one of the preceding clauses, wherein the integrated separating component comprises a geometry that conforms to a geometry of the base trough, the wall trough, and/or the lid trough.
47. The thermoplastic container according to any one of the preceding clauses, wherein the integrated separating component comprises a geometry that conforms to a geometry of a groove, or a combination of grooves, in the base trough, the wall trough, and/or the lid trough.
48. The thermoplastic container according to any one of the preceding clauses, further comprising: at least one angular wall component; wherein the integrated separating component is configured to separate the thermoplastic container along the at least one angular wall component and a junction between the base and a wall segment.
49. The thermoplastic container according to clause 48, wherein the at least one angular wall component is disposed between two adjacent wall segments.
50. The thermoplastic container according to any one of clauses 48-49, wherein the at least one angular wall component is disposed within a wall segment.
51. The thermoplastic container according to any one of clauses 48-50, wherein the angular wall component comprises an angle that ranges from 180° to 10°.
52. The thermoplastic container according to clause 51, wherein the angular wall component comprises an angle that ranges from 180° to 110°.
53. The thermoplastic container according to clause 51, wherein the angular wall component comprises an angle that ranges from 110° to 70°.
54. The thermoplastic container according to clause 51, wherein the angular wall component comprises an angle that ranges from 70° to 45°.
55. The thermoplastic container according to clause 51, wherein the angular wall component comprises an angle that ranges from 45° to 10°.
56. The thermoplastic container according to any one of clauses 48-55, wherein the angular wall component comprises a guide component configured to guide the integrated separating component along a length of an angular wall component.
57. The thermoplastic container of clause 56, wherein the guide component comprises a thickened region of a wall segment.
58. The thermoplastic container of clause 56, wherein the guide component comprises a raised projection that extends from a wall segment.
59. The thermoplastic container according to any one of clauses 48-58, wherein the angular wall component comprises a thermoplastic material that is different from a thermoplastic material of the base, the wall segments, and/or the lid.
60. The thermoplastic container according to any one of clauses 48-59, wherein the angular wall component comprises a thermoplastic material that is the same as a thermoplastic material of the base, the wall segments, and/or the lid.
61. The thermoplastic container according to any one of clauses 48-60, wherein the thermoplastic material of the angular wall component comprises one or more different mechanical properties from a thermoplastic material of the base, the wall segments, and/or the lid.
62. The thermoplastic container according to any one of clauses 48-61, comprising one or more direction-changing components that are configured to direct the integrated separating component to transition from a junction between an edge of the base and a wall segment to an angular wall component.
63. The thermoplastic container according to any one of clauses 48-62, comprising one or more direction-changing components that are configured to direct the integrated separating component to transition from a first angular wall component to a second angular wall component.
64. The thermoplastic container according to any one of clauses 48-63, comprising one or more direction-changing components that are configured to direct the integrated separating component to transition from an angular wall component to a junction between a wall segment and an edge of the lid.
65. The thermoplastic container of clause 63, wherein the direction-changing component is disposed at an intersection of a first angular wall component and a second angular wall component.
66. The thermoplastic container of clause 37, wherein the portion of the thermoplastic container is selected from the group consisting of: a base, a lid, a wall segment, and an angular wall component.
67. The thermoplastic container of clause 38, wherein the tear-initiating component is configured to initiate a tear in the thermoplastic container, and the integrated separating component is configured to propagate the tear along a junction between the base and a wall segment, an angular wall component, and/or a junction between the lid and a wall segment.
68. The thermoplastic container according to any one of clauses 48-67, wherein the integrated separating component comprises a guide component configured to guide the integrated separating component along the angular wall component.
69. The thermoplastic container according to any one of clauses 48-68, wherein the integrated separating component comprises a retention component configured to maintain the integrated separating component along the angular wall component.
70. The thermoplastic container according to any one of clauses 48-69, wherein the integrated separating component comprises a geometry that conforms to a geometry of the angular wall component.
71. The thermoplastic container according to any one of clauses 48-70, wherein the integrated separating component comprises a thermoplastic material that is the same as a thermoplastic material of the base, the wall segments, the lid, and/or an angular wall component.
72. The thermoplastic container according to any one of the preceding clauses, further comprising a rupture seam, wherein the integrated separating component is configured to separate the thermoplastic container along the rupture seam.
73. The thermoplastic container according to clause 72, wherein the rupture seam is impermeable to liquid.
74. The thermoplastic container according to clause 72, wherein the rupture seam is impermeable to air.
75. The thermoplastic container according to clause 72, wherein the rupture seam is permeable to liquid.
76. The thermoplastic container according to clause 72, wherein the rupture seam is permeable to air.
77. The thermoplastic container according to any one of clauses 72-76, wherein the rupture seam comprises a symmetric geometry.
78. The thermoplastic container according to any one of clauses 72-76, wherein the rupture seam comprises an asymmetric geometry.
79. The thermoplastic container according to clause 78, wherein the integrated separating component comprises a wedging component that is configured to separate two or more components of the asymmetric geometry of the rupture seam.
80. The thermoplastic container according to any one of clauses 72-79, wherein the rupture seam is configured to generate a blunt edge following separation by the integrated separating component.
81. The thermoplastic container according to any one of clauses 72-80, further comprising a rupture seam underlay that is configured to cover at least a portion of the rupture seam.
82. The thermoplastic container according to clause 81, wherein the rupture seam underlay is configured to cover an entire length of the rupture seam.
83. The thermoplastic container according to clause 81 or 82, wherein the rupture seam underlay is disposed on an interior surface of the thermoplastic container, an exterior surface of the thermoplastic container, or on both an interior surface and an exterior surface of the thermoplastic container.
84. The thermoplastic container according to any one of clauses 81-83, wherein the rupture seam underlay comprises a material that is impermeable to liquid.
85. The thermoplastic container according to any one of clauses 81-83, wherein the rupture seam underlay comprises a material that is impermeable to air.
86. The thermoplastic container according to any one of clauses 81-85, wherein the rupture seam underlay comprises a material that is different from the material of the thermoplastic container.
87. The thermoplastic container according to any one of clauses 81-86, wherein the rupture seam underlay comprises a material that has one or more different mechanical properties from the material of the thermoplastic container.
88. The thermoplastic container according to any one of clauses 81-87, wherein the integrated separating component is configured to separate the rupture seam underlay from the rupture seam as the integrated separating component moves along the rupture seam.
89. The thermoplastic container according to any one of clauses 1-88, comprising a recyclable material.
90. The thermoplastic container according to clause 89, wherein the recyclable material comprises a petroleum-based plastic material or a bioplastic material.
91. The thermoplastic container of clause 89, wherein the recyclable material is a degradable material.
92. The thermoplastic container of clause 91, wherein the degradable material is a biodegradable material.
93. The thermoplastic container of clause 91 or 92, wherein the degradable material is a compostable material.
94. A system comprising: a thermoplastic container, comprising: a base comprising a plurality of edges along its perimeter; a plurality of wall segments extending orthogonally from each edge of the base; and a separating component; wherein the separating component is configured to separate the thermoplastic container, thereby allowing the thermoplastic container to adopt a substantially flat configuration.
95. The system of clause 94, wherein the thermoplastic container further comprises: at least one wall trough; and at least one base trough disposed between a first edge of the base and a wall segment; wherein the separating component is configured to separate the thermoplastic container along the at least one wall trough and the at least one base trough.
96. The system of clause 94 or 95, wherein the thermoplastic container further comprises: at least one angular wall component; wherein the separating component is configured to separate the thermoplastic container along the at least one angular wall component and a junction between the base and a wall segment.
97. The system of any one of clauses 94-96, wherein the thermoplastic container further comprises a rupture seam.
98. The system according to any one of clauses 94-97, wherein the separating component is integrated into the thermoplastic container.
99. The system according to any one of clauses 94-97, wherein the separating component is disposed within an apparatus.
100. The system of clause 99, wherein the apparatus comprises a receptacle configured to receive the thermoplastic container.
101. A method for converting a thermoplastic container from a three dimensional configuration to a substantially flat configuration, the method comprising: obtaining a thermoplastic container comprising: a base comprising a plurality of edges along its perimeter; a plurality of wall segments extending orthogonally from each edge of the base; and an integrated separating component configured to separate the thermoplastic container; and separating the thermoplastic container to cause the thermoplastic container to adopt a substantially flat configuration.
102. The method of clause 101, wherein the thermoplastic container further comprises: at least one wall trough; and at least one base trough disposed between a first edge of the base and a wall segment; and wherein the method comprises passing the separating component along the at least one wall trough and the at least one base trough, thereby causing the thermoplastic container to adopt a substantially flat configuration.
103. The method of clause 101 or 102, wherein the thermoplastic container further comprises: at least one angular wall component; wherein the method comprises passing the separating component along the junction between the base and a wall segment, an angular wall component, and/or a junction between the lid and a wall segment, thereby causing the thermoplastic container to adopt a substantially flat configuration.
104. The method of any one of clauses 101-103, wherein the thermoplastic container further comprises a rupture seam, and wherein the method comprises passing the separating component along the rupture seam to separate the thermoplastic container.
105. A thermoplastic container comprising: a base comprising four edges along its perimeter; four wall segments extending orthogonally from each edge of the base; one wall trough, disposed at a junction between two adjacent wall segments; three base troughs, each disposed between a first edge of the base and a wall segment; a lid comprising a distal end and a proximal end, wherein the proximal end of the lid comprises four edges, and wherein the distal end of the lid comprises a cap; four lid troughs, each disposed between a first edge of the proximal end of the lid and a wall segment; a first direction-changing component disposed at an intersection of a base trough and the wall trough; a second direction-changing component disposed at an intersection of the wall trough and a lid trough; and an integrated separating component comprising a pull tab, wherein the integrated separating component is disposed in a depression in the base, and is configured to separate the thermoplastic container along all three base troughs, the wall trough, and all four lid troughs, thereby separating the lid from the thermoplastic container, and causing the thermoplastic container to adopt a substantially flat configuration.
106. A method for converting the thermoplastic container of clause 105 from a three dimensional configuration to a substantially flat configuration, the method comprising: removing the integrated separating component from the depression in the base; grasping the pull tab; passing the integrated separating component along the length of all three base troughs; passing the integrated separating component through the first direction-changing component to transition the integrated separating component from the third base trough into the wall trough; passing the integrated separating component along the length of the wall trough; passing the integrated separating component through the second direction-changing component to transition the integrated separating component from the wall trough into a first lid trough; passing the integrated separating component along the length of all four lid troughs to separate the lid from the thermoplastic container; and converting the thermoplastic container into a substantially flat configuration.
107. A thermoplastic container comprising: a base comprising four edges along its perimeter; four wall segments extending orthogonally from each edge of the base; one angular wall component, disposed within a wall segment; a lid comprising a distal end and a proximal end, wherein the proximal end of the lid comprises four edges, and wherein the distal end of the lid comprises a cap; a first direction-changing component disposed at an intersection of the base and the angular wall component; a second direction-changing component disposed at an intersection of the angular wall component and the lid; and an integrated separating component comprising a pull tab, wherein the integrated separating component is disposed in a depression in the base, and is configured to separate the thermoplastic container along three edges of the base, the angular wall component, and all four edges of the lid, thereby separating the lid from the thermoplastic container, and causing the thermoplastic container to adopt a substantially flat configuration.
108. A method for converting the thermoplastic container of clause 107 from a three dimensional configuration to a substantially flat configuration, the method comprising: removing the integrated separating component from the depression in the base; grasping the pull tab; passing the integrated separating component along three edges of the base; passing the integrated separating component through the first direction-changing component to transition the integrated separating component from the third edge of the base onto the angular wall component; passing the integrated separating component along the length of the angular wall component; passing the integrated separating component through the second direction-changing component to transition the integrated separating component from the angular wall component to a first edge of the lid; passing the integrated separating component along the length of all four edges of the lid to separate the lid from the thermoplastic container; and converting the thermoplastic container into a substantially flat configuration.
109. The thermoplastic container according to clause 105 or 107, further comprising a rupture seam.
110. The method according to clause 106 or 108, further comprising passing the separating component along the rupture seam to separate the thermoplastic container.
111. A thermoplastic container comprising: a base having a perimeter and one or a plurality of edges along said perimeter, one or a plurality of wall segments extending from the one or plurality of edges along said perimeter of the base, and one or a plurality of integrated separating components to irreversibly separate the container into component parts of a predetermined configuration.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A thermoplastic container comprising:
a base having a perimeter and one or a plurality of edges along said perimeter;
one or a plurality of wall segments extending from the one or plurality of edges along said perimeter of the base; and
one or a plurality of integrated separating components configured to irreversibly separate the container into one or more component parts of a predetermined configuration.

2. The thermoplastic container of claim 1, wherein the one or the plurality of integrated separating components are configured to separate the thermoplastic container in a manner that allows the thermoplastic container to adopt a substantially flat configuration.

3. The thermoplastic container according to claim 1, further comprising a rupture seam, wherein the integrated separating component is configured to separate the thermoplastic container along the rupture seam.

4-9. (canceled)

10. The thermoplastic container according to claim 1, wherein the integrated separating component comprises a wedging component that is configured to separate two or more.

11. (canceled)

12. The thermoplastic container according to claim 3, further comprising a rupture seam underlay that is configured to cover at least a portion of the rupture seam.

13-18. (canceled)

19. The thermoplastic container according to claim 12, wherein the integrated separating component is configured to separate the rupture seam underlay from the rupture seam as the integrated separating component moves along the rupture seam.

20. The thermoplastic container according to claim 1, further comprising:
at least one wall trough; and
at least one base trough disposed between an edge of the base and a wall segment;
wherein at least one of the integrated separating components is configured to separate the thermoplastic container along the at least one wall trough and the at least one base trough.

21. (canceled)

22. The thermoplastic container of claim 1, further comprising a lid having a plurality of edges, wherein the lid is connected to at least one wall segment along at least a portion of at least one edge of the lid.

23-25. (canceled)

26. The thermoplastic container according to claim 3, wherein the rupture seam, the base trough, the wall trough, comprises a guide component configured to guide the integrated separating component along a length of a rupture seam or a trough.

27. (canceled)

28. The thermoplastic container according to claim 20, wherein the rupture seam, the base trough, and/or the wall trough, comprises a retention component configured to retain the integrated separating component within a rupture seam or a trough.

29-33. (canceled)

34. The thermoplastic container according to claim 1, wherein the integrated separating component comprises a tear-initiating component configured to initiate a tear in the thermoplastic container, and the integrated separating component is configured to propagate the tear along a rupture seam, a base trough, and/or a wall trough.

35-36. (canceled)

37. The thermoplastic container according to claim 1, wherein the integrated separating component is disposed within a depression.

38-39. (canceled)

40. The thermoplastic container according to claim 1, wherein the integrated separating component comprises a guide component configured to guide the integrated separating component along a rupture seam or a trough.

41-43. (canceled)

44. The thermoplastic container according to claim 1, further comprising:
at least one angular wall component;
wherein the integrated separating component is configured to separate the thermoplastic container along the at least one angular wall component.

45-46. (canceled)

47. The thermoplastic container according to any one of claims 1-46, comprising a recyclable material selected from the group consisting of a petroleum-based plastic material, a bioplastic material, a degradable material, a biodegradable material, and a compostable material.

48-51. (canceled)

52. A system comprising:
a thermoplastic container, comprising:
a base having a perimeter and one or a plurality of edges along said perimeter;
one or a plurality of wall segments extending from the one or plurality of edges along said perimeter of the base; and
one or a plurality of separating components configured to irreversibly separate the container into one or more component parts of a predetermined configuration.

53-54. (canceled)

55. The system of claim 52, further comprising an apparatus configured to receive the thermoplastic container.

56. The system of claim 55, wherein the separating component is disposed within the apparatus, and wherein the apparatus is configured to actuate the separating component to irreversibly separate the thermoplastic container into component parts of a predetermined configuration.

57. The system of claim 55, wherein the separating component is integrated into the thermoplastic container, and wherein the apparatus is configured to operably couple to the integrated separating component and to actuate the separating component to irreversibly separate the thermoplastic container into component parts of a predetermined configuration.

58. A method for converting a thermoplastic container from a first configuration to a second configuration, the method comprising:
obtaining a thermoplastic container comprising:
a base having a perimeter and one or a plurality of edges along said perimeter;
one or a plurality of wall segments extending from the one or plurality of edges along said perimeter of the base; and
one or a plurality of integrated separating components configured to irreversibly separate the container into one or more component parts of a predetermined configuration; and
irreversibly separating the thermoplastic container to convert the thermoplastic container from the first configuration to the second configuration.

59. The method of claim 58, wherein the second configuration is a substantially flat configuration.

60. (canceled)
